(19) United States
(12) Patent Application Publication
(10) Pub. No.: US 2014/0295180 A1
(43) Pub. Date: Oct. 2, 2014

(54) ANTISTATIC PRESSURE-SENSITIVE ADHESIVE SHEET AND OPTICAL FILM

(71) Applicant: NITTO DENKO CORPORATION, OSAKA (JP)

(72) Inventors: Masato Yamagata, OSAKA (JP); Masayuki Okamoto, OSAKA (JP)

(73) Assignee: NITTO DENKO CORPORATION, Osaka (JP)

(21) Appl. No.: 14/227,185

(22) Filed: Mar. 27, 2014

(30) Foreign Application Priority Data
Mar. 28, 2013 (JP) 2013-069807

(51) Int. Cl. C09J 7/02

(52) U.S. Cl. CPC C09J 7/0264
USPC 428/354; 428/355 AC; 428/500

(57) ABSTRACT

Provided is an antistatic pressure-sensitive adhesive sheet and an optical film, excellent in antistatic properties, adhesive properties, heat resistance, and low staining properties, and capable of preventing adhesion of dirt and dust in particular and destruction of electronic components due to static electricity. Disclosed is an antistatic pressure-sensitive adhesive sheet having an antistatic substrate film; and a pressure-sensitive adhesive layer on at least one side of the antistatic substrate film, wherein the pressure-sensitive adhesive layer is formed of an antistatic pressure-sensitive adhesive composition containing a (meth)acrylic-based polymer containing a reactive ionic liquid as a monomer unit.

### BACKGROUND OF THE INVENTION

1. Field of the Invention

The present invention relates to an antistatic pressure-sensitive adhesive sheet and an optical film. More particularly, the present invention relates to an antistatic pressure-sensitive adhesive sheet having a pressure-sensitive adhesive layer excellent in antistatic properties, adhesive properties, and low staining properties, and capable of preventing adhesion of particularly dirt and dust, and destruction of electronic components due to static electricity, and also relates to an optical film that is formed by laminating the pressure-sensitive adhesive sheet thereto.

2. Description of the Related Art

A product having a high insulation resistance, such as plastics and the like, has a property of accumulating static electricity (that is, being electrically charged) which is generated by friction or peeling after laminating between plastic and plastic or between plastic and another object as a result of failure to leak the electricity. The aforesaid property might cause not only adsorption of dirt, dust and the like contained in the air, bonding of paper and paper or of film and film, uncomfortable feeling by an electricity shock, but also various troubles and malfunctions such as erroneous actions and destruction of a memory due to static electricity, when used in electronic or electrical equipment and machineries, office automation equipment and machineries or the like. In order to avoid such troubles or malfunctions, it is necessary to control the surface specific resistivity of an object to be charged, and thus an antistatic agent is usually employed.

As an antistatic method for plastic products, there are generally known a method in which an antistatic agent is internally added (kneaded) to the product and a method in which an antistatic agent is applied to the surface thereof. Further, a pressure-sensitive adhesive sheet (or a pressure-sensitive adhesive tape) or a surface protective film that requires an antistatic property is formed by known methods such as a method of providing a pressure-sensitive adhesive layer on one side of a plastic substrate film to which an antistatic agent is internally added, a method of providing a pressure-sensitive adhesive layer on one side of a plastic substrate film and providing an antistatic layer on the opposite side, or a method of adding an antistatic agent to a pressure-sensitive adhesive layer.

However, a plastic substrate film to which an antistatic agent is internally added is likely to impair characteristics inherent in it. On the other hand, an antistatic layer which is formed on the opposite side of the pressure-sensitive adhesive layer brings about a problem that the adhesion between the antistatic layer and, for instance, an easy-to-print layer or a hard coat layer, is reduced in the case where such a layer is formed on the antistatic layer. In addition, there may also occur a possibility such that antistatic properties cannot be maintained due to the loss of the antistatic layer as a result of friction, rubbing, and immersion. Further, in the case of adding an antistatic agent into a pressure-sensitive adhesive layer, the antistatic agent bleeds out on the side of an adherend (an object to be protected) that is in contact with the pressure-sensitive adhesive layer, so that there is a risk of staining the adherend and reducing the adhesive properties (Patent Document 1).

In addition, as a method for imparting antistatic properties to a pressure-sensitive adhesive sheet or the like, there is known a method of providing an intermediate layer (antistatic layer) having an antistatic property, between a substrate film and the pressure-sensitive adhesive layer (Patent Document 2). Since this antistatic layer is an intermediate layer, it is possible to solve the problems such that the antistatic layer is lost like one provided on the outer surface of the substrate film and the antistatic agent bleeds out to the adherend side. However, in the case of such an antistatic layer, since a counter anion of an ionic functional group forming an ionic binder resin as an antistatic agent is a chlorine ion, there is a possibility that such an ion acts to reduce heat resistance and cause corrosion. In addition, leakage effects (antistatic effect) of the electric charges are not sufficient because the antistatic layer is not the outermost layer, and a problem may arise.

### PRIOR ART DOCUMENTS

### Patent Documents

Patent Document 1: JP-A-6-128539
Patent Document 2: JP-A-2007-31534

### SUMMARY OF THE INVENTION

An object of the present invention is to solve the problem in the conventional antistatic pressure-sensitive adhesive sheet and provide an antistatic pressure-sensitive adhesive sheet and an optical film, having a pressure-sensitive adhesive layer excellent in antistatic properties, adhesive properties, and low staining properties and capable of preventing adhesion of particularly dirt and dust and destruction of electronic components due to static electricity.

That is, the antistatic pressure-sensitive adhesive sheet of the present invention is an antistatic pressure-sensitive adhesive sheet having an antistatic substrate film; and a pressure-sensitive adhesive layer on at least one side of the antistatic substrate film, wherein the pressure-sensitive adhesive layer is formed of at least an antistatic pressure-sensitive adhesive composition including a (meth)acrylic-based polymer containing a reactive ionic liquid as a monomer unit.

In the antistatic pressure-sensitive adhesive sheet of the present invention, the reactive ionic liquid content is preferably 0.1 to 50% by mass, based on the total constituent units of the (meth)acrylic-based polymer.

In the antistatic pressure-sensitive adhesive sheet of the present invention, the reactive ionic liquid is preferably represented by the following general formula (1) and/or (2):

CH₂═C(R¹)COOZX⁺Y⁻ (1)

CH₂═C(R¹)CONHZX⁺Y⁻ (2)

[in the formulae (1) and (2), R¹ is a hydrogen atom or a methyl group, X⁺ is a cation moiety, and Y⁻ is an anion. Z represents an alkylene group having 1 to 3 carbon atoms].

In the antistatic pressure-sensitive adhesive sheet of the present invention, the cation moiety is preferably a quaternary ammonium group.

In the antistatic pressure-sensitive adhesive sheet of the present invention, the anion is preferably a fluorine-containing anion.

In the antistatic pressure-sensitive adhesive sheet of the present invention, the antistatic substrate film layer has an antistatic layer on at least one side of the substrate layer and the antistatic layer is preferably a layer containing at least one kind selected from the group consisting of a metal film, a conductive filler, an electronically conductive polymer, and an ion conductive polymer. Further, the antistatic substrate film may mean an antistatic-treated film.

In the antistatic pressure-sensitive adhesive sheet of the present invention, the ion conductive polymer is preferably a polymer containing a reactive ionic liquid as a monomer unit.

In the antistatic pressure-sensitive adhesive sheet of the present invention, the substrate layer is preferably a plastic film.

The antistatic pressure-sensitive adhesive sheet of the present invention is preferably used for surface protection.

The antistatic pressure-sensitive adhesive sheet of the present invention is preferably used for electronic components production and a shipment process.

An optical film with an antistatic pressure-sensitive adhesive sheet of the present invention is preferably formed by laminating the pressure-sensitive adhesive sheet to an optical film.

### BRIEF DESCRIPTION OF THE DRAWING

FIG. 1 is a schematic view illustrating a constitution of the antistatic pressure-sensitive adhesive sheet according to the present invention.

### DETAILED DESCRIPTION OF THE PREFERRED EMBODIMENTS

Hereinafter, embodiments of the present invention will be described in detail.

### <Antistatic Pressure-Sensitive Adhesive Sheet>

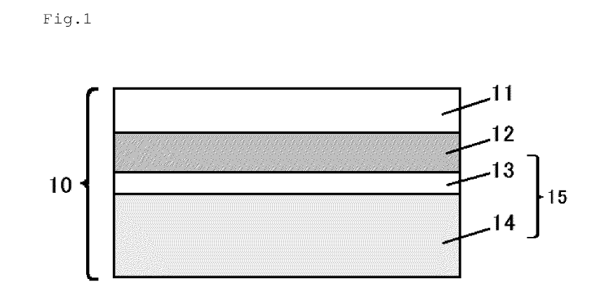

The antistatic pressure-sensitive adhesive sheet of the present invention (hereinafter, also simply referred to as pressure-sensitive adhesive sheet) is an antistatic pressure-sensitive adhesive sheet having an antistatic substrate film; and a pressure-sensitive adhesive layer on at least one side of the antistatic substrate film, wherein the pressure-sensitive adhesive layer is formed of at least an antistatic pressure-sensitive adhesive composition (hereinafter, also simply referred to as pressure-sensitive adhesive composition) containing a (meth)acrylic-based polymer containing a reactive ionic liquid as a monomer unit. As the antistatic pressure-sensitive adhesive sheet specifically, a typical constitution example is schematically shown in FIG. 1. An antistatic pressure-sensitive adhesive sheet 10 exemplified is formed of a substrate layer (e.g. polyester film) 14, an antistatic layer 13 provided on one side thereof and further a pressure-sensitive adhesive layer 12 on the antistatic layer 13. The antistatic pressure-sensitive adhesive sheet 10 is used by laminating the pressure-sensitive adhesive layer 12 to an adherend (an object to be protected, e.g. surface of optical components such as polarizing plate, etc.). As shown in FIG. 1, the antistatic pressure-sensitive adhesive sheet 10 before use (i.e. before laminating to the adherend) may be present in a form where the surface (laminating surface to the adherend) of the pressure-sensitive adhesive layer 12 is protected by a separator 11 having a release layer side on at least the pressure-sensitive adhesive layer 12 side. The constitution of the antistatic pressure-sensitive adhesive sheet will be explained in detail below. The (meth)acrylic-based polymer in the present invention refers to an acrylic-based polymer and/or a methacrylic-based polymer, and a (meth)acrylate refers to an acrylate and/or a methacrylate.

### <Pressure-Sensitive Adhesive Composition and Pressure-Sensitive Adhesive Layer>

The pressure-sensitive adhesive layer constituting the antistatic pressure-sensitive adhesive sheet of the present invention contains as an essential component at least a (meth)acrylic-based polymer containing a reactive ionic liquid as a monomer unit. The “reactive ionic liquid” in the present invention refers to an ionic liquid that has a polymerizable (reactive double bond) functional group and a cation moiety and/or an anion moiety (either or both) constituting the ionic liquid; that is in a state of liquid (liquid form) at any temperature within a range of 0 to 150° C.; that is a non-volatile melt salt; and that is transparent. In addition, the polymerizable functional group includes, for example, a vinyl group, an allyl group, a (meth)acryloyl group, and the like. Of them, a (meth)acryloyl group and a vinyl group are preferable and a (meth)acryloyl group is particularly preferable, in view of the copolymerization properties.

The cation moiety of the reactive ionic liquid is not particularly limited, but examples thereof include a quaternary ammonium cation, an imidazolium cation, a pyridinium cation, a piperidinium cation, a pyrrolidinium cation, a quaternary phosphonium cation, a trialkylsulphonium cation, a pyrrole cation, a pyrazolium cation, a guanidium cation, and the like, and among which it is more preferable to use a quaternary ammonium cation, an imidazolium cation, a pyridinium cation, a piperidinium cation, a pyrrolidinium cation, a quaternary phosphonium cation, or a trialkylsulphonium cation.

In addition, in the anion moiety constituting the reactive ionic liquid, the anion includes SCN⁻, BF₄⁻, PF₆⁻, NO₃⁻, CH₃COO⁻, CF₃COO⁻, CH₃SO₃⁻, CF₃SO₃—, (FSO₂)₂N⁻, (CF₃SO₂)₂N⁻, (CF₃SO₂)₃C⁻, ASF₆⁻. SbF₆⁻, NbF₆⁻, TaF₆⁻, F(HF)ₙ⁻, (CN)₂N⁻, C₄F₉SO₃⁻, (C₂F₅SO₂)₂N⁻, C₃F₇COO⁻, (CF₃SO₂)(CF₃CO)N⁻, B(CN)₄⁻, C(CN)₃⁻, N(CN)₂⁻, CH₃OSO₃⁻, C₂H₅OSO₃⁻, C₄H₉OSO₃⁻, C₆H₁₃OSO₃⁻, C₈H₁₇OSO₃⁻, p-toluenesulfonate anion, 2-(2-methoxyethyl)ethyl sulfate anion, (C₂F₅)₃ PF₃, and the like, and in particular, an anion component containing a fluorine atom (fluorine-containing anion) is preferable because an ionic liquid with a low melting point is obtained and is excellent in antistatic properties. Further, it is preferable not to use a chlorine ion, a bromine ion or the like as the anion, because they have corrosion properties.

The reactive ionic liquid can be appropriately selected from combinations of the cation moiety and anion moiety described above to be used, and includes specifically various ionic liquids shown below.

The imidazolium cation-based ionic liquid includes:

an ionic liquid containing a 1-alkyl-3-vinylimidazolium cation, such as 1-alkyl-3-vinylimidazolium tetrafluoroborate,
1-alkyl-3-vinylimidazolium trifluoroacetate,
1-alkyl-3-vinylimidazolium heptafluorobutyrate,
1-alkyl-3-vinylimidazolium trifluoromethanesulfonate,
1-alkyl-3-vinylimidazolium perfluorobutanesulfonate,
1-alkyl-3-vinylimidazolium bis(trifluoromethanesulfonyl)imide,
1-alkyl-3-vinylimidazolium bis(pentafluoroethanesulfonyl)imide,
1-alkyl-3-vinylimidazolium tris(trifluoromethanesulfonyl)imide,
1-alkyl-3-vinylimidazolium hexafluorophosphate, 1-alkyl-3-vinylimidazolium(trifluoromethanesulfonyl)trifluo roacetamide, 1-alkyl-3-vinylimidazolium dicyanamide,
1-alkyl-3-vinylimidazolium thiocyanate, and the like;

an ionic liquid containing a 1,2-dialkyl-3-vinylimidazolium cation, such as
1,2-dialkyl-3-vinylimidazolium bis(fluorosulfonyl)imide,
1,2-dialkyl-3-vinylimidazolium bis(trifluoromethanesulfonyl)imide,
1,2-dialkyl-3-vinylimidazolium dicyanamide,
1,2-dialkyl-3-vinylimidazolium thiocyanate, and the like;

an ionic liquid containing a 2-alkyl-1,3-divinylimidazolium cation, such as
2-alkyl-1,3-divinylimidazolium bis(fluorosulfonyl)imide,
2-alkyl-1,3-divinylimidazolium bis(trifluoromethanesulfonyl)imide,
2-alkyl-1,3-divinylimidazolium dicyanamide,
2-alkyl-1,3-divinylimidazolium thiocyanate, and the like;

an ionic liquid containing a 1-vinylimidazolium cation, such as 1-vinylimidazolium bis(fluorosulfonyl)imide,
1-vinylimidazolium bis(trifluoromethanesulfonyl)imide,
1-vinylimidazolium dicyanamide, 1-vinylimidazolium thiocyanate, and the like;

an ionic liquid containing a 1-alkyl-3-(meth)acryloyloxyalkylimidazolium cation, such as
1-alkyl-3-(meth)acryloyloxyalkylimidazolium tetrafluoroborate,
1-alkyl-3-(meth)acryloyloxyalkylimidazolium trifluoroacetate,
1-alkyl-3-(meth)acryloyloxyalkylimidazolium heptafluorobutyrate,
1-alkyl-3-(meth)acryloyloxyalkylimidazolium trifluoromethanesulfonate,
1-alkyl-3-(meth)acryloyloxyalkylimidazolium perfluorobutanesulfonate,
1-alkyl-3-(meth)acryloyloxyalkylimidazolium bis(trifluoromethanesulfonyl)imide,
1-alkyl-3-(meth)acryloyloxyalkylimidazolium bis(pentafluoroethanesulfonyl)imide,
1-alkyl-3-(meth)acryloyloxyalkylimidazolium tris(trifluoromethanesulfonyl)imide,
1-alkyl-3-(meth)acryloyloxyalkylimidazolium hexafluorophosphate,
1-alkyl-3-(meth)acryloyloxyalkylimidazolium (trifluoromethanesulfonyl)trifluoroacetamide,
1-alkyl-3-(meth)acryloyloxyalkylimidazolium dicyanamide,
1-alkyl-3-(meth)acryloyloxyalkylimidazolium thiocyanate, and the like;

an ionic liquid containing a 1-alkyl-3-(meth)acryloylaminoalkylimidazolium cation, such as
1-alkyl-3-(meth)acryloylaminoalkylimidazolium tetrafluoroborate,
1-alkyl-3-(meth)acryloylaminoalkylimidazolium trifluoroacetate,
1-alkyl-3-(meth)acryloylaminoalkylimidazolium heptafluorobutyrate,
1-alkyl-3-(meth)acryloylaminoalkylimidazolium trifluoromethanesulfonate,
1-alkyl-3-(meth)acryloylaminoalkylimidazolium perfluorobutanesulfonate,
1-alkyl-3-(meth)acryloylaminoalkylimidazolium bis(trifluoromethanesulfonyl)imide,
1-alkyl-3-(meth)acryloylaminoalkylimidazolium bis(pentafluoroethanesulfonyl)imide,
1-alkyl-3-(meth)acryloylaminoalkylimidazolium tris(trifluoromethanesulfonyl)imide,
1-alkyl-3-(meth)acryloylaminoalkylimidazolium hexafluorophosphate,
1-alkyl-3-(meth)acryloylaminoalkylimidazolium (trifluoromethanesulfonyl)trifluoroacetamide,
1-alkyl-3-(meth)acryloylaminoalkylimidazolium dicyanamide,
1-alkyl-3-(meth)acryloylaminoalkylimidazolium thiocyanate, and the like;

an ionic liquid containing a 1,2-dialkyl-3-(meth)acryloyloxyalkylimidazolium cation, such as 1,2-dialkyl-3-(meth)acryloyloxyalkylimidazolium bis(fluorosulfonyl)imide,
1,2-dialkyl-3-(meth)acryloyloxyalkylimidazolium bis(trifluoromethanesulfonyl)imide,
1,2-dialkyl-3-(meth)acryloyloxyalkylimidazolium dicyanamide,
1,2-dialkyl-3-(meth)acryloyloxyalkylimidazolium thiocyanate, and the like;

an ionic liquid containing a 1,2-dialkyl-3-(meth)acryloylaminoalkylimidazolium cation, such as 1,2-dialkyl-3-(meth)acryloylaminoalkylimidazolium bis(fluorosulfonyl)imide,
1,2-dialkyl-3-(meth)acryloylaminoalkylimidazolium bis(trifluoromethanesulfonyl)imide,
1,2-dialkyl-3-(meth)acryloylaminoalkylimidazolium dicyanamide,
1,2-dialkyl-3-(meth)acryloylaminoalkylimidazolium thiocyanate, and the like;

an ionic liquid containing a 2-alkyl-1,3-di(meth)acryloyloxyalkylimidazolium cation, such as 2-alkyl-1,3-di(meth)acryloyloxyalkylimidazolium bis(fluorosulfonyl)imide,
2-alkyl-1,3-di(meth)acryloyloxyalkylimidazolium bis(trifluoromethanesulfonyl)imide,
2-alkyl-1,3-di(meth)acryloyloxyalkylimidazolium dicyanamide,
2-alkyl-1,3-di(meth)acryloyloxyalkylimidazolium thiocyanate, and the like;

an ionic liquid containing a 2-alkyl-1,3-di(meth)acryloylaminoalkylimidazolium cation, such as 2-alkyl-1,3-di(meth)acryloylaminoalkylimidazolium bis(fluorosulfonyl)imide,
2-alkyl-1,3-di(meth)acryloylaminoalkylimidazolium bis(trifluoromethanesulfonyl)imide,
2-alkyl-1,3-di(meth)acryloylaminoalkylimidazolium dicyanamide, 2-alkyl-1,3-di(meth)acryloylaminoimidazolium thiocyanate, and the like;

an ionic liquid containing a 1-(meth)acryloyloxyalkylimidazolium cation, such as
1-(meth)acryloyloxyalkylimidazolium bis(fluorosulfonyl)imide,
1-(meth)acryloyloxyalkylimidazolium bis(trifluoromethanesulfonyl)imide,
1-(meth)acryloyloxyalkylimidazolium dicyanamide,
1-(meth)acryloyloxyalkylimidazoliumthiocyanate, and the like; and

an ionic liquid containing a 1-(meth)acryloylaminoalkylimidazolium cation, such as
1-(meth)acryloylaminoalkylimidazolium bis(fluorosulfonyl)imide,
1-(meth)acryloylaminoalkylimidazolium bis(trifluoromethanesulfonyl)imide,
1-(meth)acryloylaminoalkylimidazolium dicyanamide,
1-(meth)acryloylaminoalkylimidazolium thiocyanate, and the like.

Further, the alkyl substituent described above is an alkyl group of preferably 1 to 16 carbon atoms, especially preferably 1 to 12 carbon atoms, and further preferably 1 to 6 carbon atoms.

The pyridinium cation-based ionic liquid includes:

an ionic liquid containing a 1-vinylpyridinium cation, such as 1-vinylpyridinium bis(fluorosulfonyl)imide,
1-vinylpyridinium bis(trifluoromethanesulfonyl)imide,
1-vinylpyridiniumdicyanamide, 1-vinylpyridiniumthiocyanate, and the like;

an ionic liquid containing a 1-(meth)acryloyloxyalkylpyridinium cation, such as
1-(meth)acryloyloxyalkylpyridinium bis(fluorosulfonyl)imide,
1-(meth)acryloyloxyalkylpyridinium bis(trifluoromethanesulfonyl)imide,
1-(meth)acryloyloxyalkylpyridinium dicyanamide,
1-(meth)acryloyloxyalkylpyridinium thiocyanate, and the like;

an ionic liquid containing a 1-(meth)acryloylaminoalkylpyridinium cation, such as
1-(meth)acryloylaminoalkylpyridinium bis(fluorosulfonyl)imide,
1-(meth)acryloylaminoalkylpyridinium bis(trifluoromethanesulfonyl)imide,
1-(meth)acryloylaminoalkylpyridinium dicyanamide,
1-(meth)acryloylaminoalkylpyridinium thiocyanate, and the like;

an ionic liquid containing a 2-alkyl-1-vinylpyridinium cation, such as 2-alkyl-1-vinylpyridinium bis(fluorosulfonyl)imide, 2-alkyl-1-vinylpyridinium bis(trifluoromethanesulfonyl)imide,
2-alkyl-1-vinylpyridinium dicyanamide,
2-alkyl-1-vinylpyridinium thiocyanate, and the like;

an ionic liquid containing a 2-alkyl-1-(meth)acryloyloxyalkylpyridinium cation, such as
2-alkyl-1-(meth)acryloyloxyalkylpyridinium bis(fluorosulfonyl)imide,
2-alkyl-1-(meth)acryloyloxyalkylpyridinium bis(trifluoromethanesulfonyl)imide,
2-alkyl-1-(meth)acryloyloxyalkylpyridinium dicyanamide,
2-alkyl-1-(meth)acryloyloxyalkylpyridinium thiocyanate, and the like;

an ionic liquid containing a 2-alkyl-1-(meth)acryloylaminoalkylpyridinium cation, such as
2-alkyl-1-(meth)acryloylaminoalkylpyridinium bis(fluorosulfonyl)imide,
2-alkyl-1-(meth)acryloylaminoalkylpyridinium bis(trifluoromethanesulfonyl)imide,
2-alkyl-1-(meth)acryloylaminoalkylpyridinium dicyanamide,
2-alkyl-1-(meth)acryloylaminoalkylpyridinium thiocyanate, and the like;

an ionic liquid containing a 3-alkyl-1-vinylpyridinium cation, such as 3-alkyl-1-vinylpyridinium bis(fluorosulfonyl)imide, 3-alkyl-1-vinylpyridinium bis(trifluoromethanesulfonyl)imide,
3-alkyl-1-vinylpyridinium dicyanamide,
3-alkyl-1-vinylpyridinium thiocyanate, and the like;

an ionic liquid containing a 3-alkyl-1-(meth)acryloyloxyalkylpyridinium cation, such as
3-alkyl-1-(meth)acryloyloxyalkylpyridinium bis(fluorosulfonyl)imide,
3-alkyl-1-(meth)acryloyloxyalkylpyridinium bis(trifluoromethanesulfonyl)imide,
3-alkyl-1-(meth)acryloyloxyalkylpyridinium dicyanamide,
3-alkyl-1-(meth)acryloyloxyalkylpyridinium thiocyanate, and the like;

an ionic liquid containing a 3-alkyl-1-(meth)acryloylaminoalkylpyridinium cation, such as
3-alkyl-1-(meth)acryloylaminoalkylpyridinium bis(fluorosulfonyl)imide,
3-alkyl-1-(meth)acryloylaminoalkylpyridinium bis(trifluoromethanesulfonyl)imide,
3-alkyl-1-(meth)acryloylaminoalkylpyridinium dicyanamide,
3-alkyl-1-(meth)acryloylaminoalkylpyridinium thiocyanate, and the like;

an ionic liquid containing a 4-alkyl-1-vinylpyridinium cation, such as 4-alkyl-1-vinylpyridinium bis(fluorosulfonyl)imide, 4-alkyl-1-vinylpyridinium bis(trifluoromethanesulfonyl)imide,
4-alkyl-1-vinylpyridinium dicyanamide,
4-alkyl-1-vinylpyridinium thiocyanate, and the like;

an ionic liquid containing a 4-alkyl-1-(meth)acryloyloxyalkylpyridinium cation, such as
4-alkyl-1-(meth)acryloyloxyalkylpyridinium bis(fluorosulfonyl)imide,
4-alkyl-1-(meth)acryloyloxyalkylpyridinium bis(trifluoromethanesulfonyl)imide,
4-alkyl-1-(meth)acryloyloxyalkylpyridinium dicyanamide,
4-alkyl-1-(meth)acryloyloxyalkylpyridinium thiocyanate, and the like; and

an ionic liquid containing a 4-alkyl-1-(meth)acryloylaminoalkylpyridinium cation, such as
4-alkyl-1-(meth)acryloylaminoalkylpyridinium bis(fluorosulfonyl)imide,
4-alkyl-1-(meth)acryloylaminoalkylpyridinium bis(trifluoromethanesulfonyl)imide,
4-alkyl-1-(meth)acryloylaminoalkylpyridinium dicyanamide,
4-alkyl-1-(meth)acryloylaminoalkylpyridinium thiocyanate, and the like.

Further, the alkyl substituent described above is an alkyl group having preferably 1 to 16 carbon atoms, especially preferably 1 to 12 carbon atoms, and further preferably 1 to 6 carbon atoms.

The piperidinium cation-based ionic liquid includes:

an ionic liquid containing a 1-alkyl-1-vinylalkylpiperidinium cation, such as
1-alkyl-1-vinylalkylpiperidinium bis(fluorosulfonyl)imide,
1-alkyl-1-vinylalkylpiperidinium bis(trifluoromethanesulfonyl)imide,
1-alkyl-1-vinylalkylpiperidinium dicyanamide,
1-alkyl-1-vinylalkylpiperidinium thiocyanate, and the like;

an ionic liquid containing a 1-alkyl-1-(meth)acryloyloxyalkylpiperidinium cation, such as
1-alkyl-1-(meth)acryloyloxyalkylpiperidinium bis(fluorosulfonyl)imide,
1-alkyl-1-(meth)acryloyloxyalkylpiperidinium bis(trifluoromethanesulfonyl)imide,
1-alkyl-1-(meth)acryloyloxyalkylpiperidinium dicyanamide,
1-alkyl-1-(meth)acryloyloxyalkylpiperidinium thiocyanate, and the like; and

an ionic liquid containing a 1-alkyl-1-(meth)acryloylaminoalkylpiperidinium cation, such as 1-alkyl-1-(meth)acryloylaminoalkylpiperidinium bis(fluorosulfonyl)imide,
1-alkyl-1-(meth)acryloylaminoalkylpiperidinium bis(trifluoromethanesulfonyl)imide,
1-alkyl-1-(meth)acryloylaminoalkylpiperidinium dicyanamide,
1-alkyl-1-(meth)acryloylaminoalkylpiperidinium thiocyanate, and the like.

Further, the alkyl substituent described above is an alkyl group having preferably 1 to 16 carbon atoms, especially preferably 1 to 12 carbon atoms, and further preferably 1 to 6 carbon atoms.

The pyrrolidinium cation-based ionic liquid includes:

an ionic liquid containing a 1-alkyl-1-vinylalkylpyrrolidinium cation, such as 1-alkyl-1-vinylalkylpyrrolidinium bis(fluorosulfonyl)imide,
1-alkyl-1-vinylalkylpyrrolidinium bis(trifluoromethanesulfonyl)imide,
1-alkyl-1-vinylalkylpyrrolidinium dicyanamide,
1-alkyl-1-vinylalkylpyrrolidinium thiocyanate, and the like;

an ionic liquid containing a 1-alkyl-1-(meth)acryloyloxyalkylpyrrolidiniumcation, such as
1-alkyl-1-(meth)acryloyloxyalkylpyrrolidinium bis(fluorosulfonyl)imide,
1-alkyl-1-(meth)acryloyloxyalkylpyrrolidinium bis(trifluoromethanesulfonyl)imide,
1-alkyl-1-(meth)acryloyloxyalkylpyrrolidinium dicyanamide,
1-alkyl-1-(meth)acryloyloxyalkylpyrrolidinium thiocyanate, and the like; and

an ionic liquid containing a 1-alkyl-1-(meth)acryloylaminoalkylpyrrolidinium cation, such as 1-alkyl-1-(meth)acryloylaminoalkylpyrrolidinium bis(fluorosulfonyl)imide,
1-alkyl-1-(meth)acryloylaminoalkylpyrrolidinium bis(trifluoromethanesulfonyl)imide,
1-alkyl-1-(meth)acryloylaminoalkylpyrrolidinium dicyanamide,
1-alkyl-1-(meth)acryloylaminoalkylpyrrolidinium thiocyanate, and the like.

Further, the alkyl substituent described above is an alkyl group having preferably 1 to 16 carbon atoms, especially preferably 1 to 12 carbon atoms, and further preferably 1 to 6 carbon atoms.

The trialkylsulfonium cation-based ionic liquid includes:

an ionic liquid containing a dialkyl(vinyl)sulfonium cation, such as dialkyl(vinyl)sulfonium bis(fluorosulfonyl)imide, dialkyl(vinyl)sulfonium bis(trifluoromethanesulfonyl)imide, dialkyl(vinyl)sulfonium dicyanamide, dialkyl(vinyl)sulfonium thiocyanate, and the like;

an ionic liquid containing a dialkyl((meth)acryloyloxyalkyl)sulfonium cation, such as dialkyl((meth)acryloyloxyalkyl)sulfonium bis(fluorosulfonyl)imide, dialkyl((meth)acryloyloxyalkyl)sulfonium bis(trifluoromethanesulfonyl)imide, dialkyl((meth)acryloyloxyalkyl)sulfonium dicyanamide, dialkyl((meth)acryloyloxyalkyl)sulfoniumthiocyanate, and the like; and

an ionic liquid containing a dialkyl((meth)acryloylaminoalkyl)sulfonium cation, such as dialkyl((meth)acryloylaminoalkyl)sulfonium bis(fluorosulfonyl)imide,

dialkyl((meth)acryloylaminoalkyl)sulfonium bis(trifluoromethanesulfonyl)imide, dialkyl((meth)acryloylaminoalkyl)sulfonium dicyanamide, dialkyl((meth)acryloylaminoalkyl)sulfonium thiocyanate, and the like.

Further, the alkyl substituent described above is an alkyl group having preferably 1 to 16 carbon atoms, especially preferably 1 to 12 carbon atoms, and further preferably 1 to 6 carbon atoms.

The quaternary phosphonium cation-based ionic liquid includes:

an ionic liquid containing a trialkyl(vinyl)phosphonium cation, such as trialkyl(vinyl)phosphonium bis(fluorosulfonyl)imide, trialkyl(vinyl)phosphonium bis(trifluoromethanesulfonyl)imide, trialkyl(vinyl)phosphonium dicyanamide, trialkyl(vinyl)phosphonium thiocyanate, and the like;

an ionic liquid containing a trialkyl((meth)acryloyloxyalkyl)phosphonium cation, such as trialkyl((meth)acryloyloxyalkyl)phosphonium bis(fluorosulfonyl)imide, trialkyl((meth)acryloyloxyalkyl)phosphonium bis(trifluoromethanesulfonyl)imide, trialkyl((meth)acryloyloxyalkyl)phosphonium dicyanamide, trialkyl((meth)acryloyloxyalkyl) phosphonium thiocyanate, and the like; and

an ionic liquid containing a trialkyl((meth)acryloylaminoalkyl)phosphoniumcation, such as trialkyl((meth)acryloylaminoalkyl)phosphonium bis(fluorosulfonyl)imide, trialkyl((meth)acryloylaminoalkyl)phosphonium bis(trifluoromethanesulfonyl)imide, trialkyl((meth)acryloylaminoalkyl)phosphonium dicyanamide, trialkyl((meth)acryloylaminoalkyl)phosphonium thiocyanate, and the like;

Further, the alkyl substituent described above is an alkyl group having preferably 1 to 16 carbon atoms, especially preferably 1 to 12 carbon atoms, and further preferably 1 to 6 carbon atoms.

In addition, the quaternary ammonium cation-based ionic liquid includes:

an ionic liquid containing an

N,N,N-trialkyl-N-vinylammonium cation, such as
N,N,N-trialkyl-N-vinylammonium tetrafluoroborate,
N,N,N-trialkyl-N-vinylammonium trifluoroacetate,
N,N,N-trialkyl-N-vinylammonium heptafluorobutyrate,
N,N,N-trialkyl-N-vinylammonium trifluoromethanesulfonate,
N,N,N-trialkyl-N-vinylammonium perfluorobutanesulfonate,
N,N,N-trialkyl-N-vinylammonium bis(trifluoromethanesulfonyl)imide,
N,N,N-trialkyl-N-vinylammonium bis(pentafluoroethanesulfonyl)imide,
N,N,N-trialkyl-N-vinylammonium tris(trifluoromethanesulfonyl)imide,
N,N,N-trialkyl-N-vinylammonium hexafluorophosphate, N,N,N-trialkyl-N-vinylammonium (trifluoromethanesulfonyl)trifluoroacetamide,
N,N,N-trialkyl-N-vinylammonium dicyanamide,
N,N,N-trialkyl-N-vinylammonium thiocyanate, and the like;

an ionic liquid containing an N,N,N-trialkyl-N-(meth)acryloyloxyalkylammonium cation, such as N,N,N-trialkyl-N-(meth)acryloyloxyalkylammonium tetrafluoroborate,
N,N,N-trialkyl-N-(meth)acryloyloxyalkylammonium trifluoroacetate,
N,N,N-trialkyl-N-(meth)acryloyloxyalkylammonium heptafluorobutyrate,
N,N,N-trialkyl-N-(meth)acryloyloxyalkylammonium trifluoromethanesulfonate,
N,N,N-trialkyl-N-(meth)acryloyloxyalkylammonium perfluorobutanesulfonate,
N,N,N-trialkyl-N-(meth)acryloyloxyalkylammonium bis(trifluoromethanesulfonyl)imide,
N,N,N-trialkyl-N-(meth)acryloyloxyalkylammonium bis(pentafluoroethanesulfonyl)imide,
N,N,N-trialkyl-N-(meth)acryloyloxyalkylammonium tris(trifluoromethanesulfonyl)imide,
N,N,N-trialkyl-N-(meth)acryloyloxyalkylammonium hexafluorophosphate,
N,N,N-trialkyl-N-(meth)acryloyloxyalkylammonium (trifluoromethanesulfonyl)trifluoroacetamide,
N,N,N-trialkyl-N-(meth)acryloyloxyalkylammonium dicyanamide,
N,N,N-trialkyl-N-(meth)acryloyloxyalkylammonium thiocyanate, and the like; and

an ionic liquid containing an N,N,N-trialkyl-N-(meth)acryloylaminoalkylammonium cation, such as N,N,N-trialkyl-N-(meth)acryloylaminoalkylammonium tetrafluoroborate,
N,N,N-trialkyl-N-(meth)acryloylaminoalkylammonium trifluoroacetate,
N,N,N-trialkyl-N-(meth)acryloylaminoalkylammonium heptafluorobutyrate,
N,N,N-trialkyl-N-(meth)acryloylaminoalkylammonium trifluoromethanesulfonate,
N,N,N-trialkyl-N-(meth)acryloylaminoalkylammonium perfluorobutanesulfonate,
N,N,N-trialkyl-N-(meth)acryloylaminoalkylammonium bis(trifluoromethanesulfonyl)imide,
N,N,N-trialkyl-N-(meth)acryloylaminoalkylammonium bis(pentafluoroethanesulfonyl)imide,
N,N,N-trialkyl-N-(meth)acryloylaminoalkylammonium tris(trifluoromethanesulfonyl)imide,
N,N,N-trialkyl-N-(meth)acryloylaminoalkylammonium hexafluorophosphate,
N,N,N-trialkyl-N-(meth)acryloylaminoalkylammonium (trifluoromethanesulfonyl)trifluoroacetamide,
N,N,N-trialkyl-N-(meth)acryloylaminoalkylammonium dicyanamide,

N,N,N-trialkyl-N-(meth)acryloylaminoalkylammonium thiocyanate, and the like.

Further, the alkyl substituent described above is an alkyl group having preferably 1 to 16 carbon atoms, especially preferably 1 to 12 carbon atoms, and further preferably 1 to 6 carbon atoms.

Further, it is possible to use the reactive ionic liquid without any particular limitation, but a reactive ionic liquid represented by the following general formula (1) and/or (2) is more preferable. By containing a (meth)acrylic-based polymer that contains a reactive ionic liquid as a monomer unit, in the antistatic pressure-sensitive adhesive composition, a pressure-sensitive adhesive layer that is formed of the antistatic pressure-sensitive adhesive composition can incorporate the reactive ionic liquid exhibiting an antistatic effect into the polymer skeleton so that the bleeding out of the antistatic component can be prevented. In addition, the reactive ionic liquid exists in the form of a liquid (liquid state) at any temperature within a range of 0 to 150° C., and is a non-volatile melt salt that is transparent, and thus the resulting pressure-sensitive adhesive layer is useful because of satisfactory antistatic properties (high conductivity), heat resistance (thermal stability), transparency, and low staining properties. Moreover, the antistatic component is a reactive ionic liquid that is a fluid and thus such a component is preferable because of easy formation of a uniform coating film as well as excellent workability when the component is made into an antistatic pressure-sensitive adhesive composition (solution) and applied to the antistatic substrate film.

CH₂═C(R¹)COOZX⁺Y⁻ (1)

CH₂═C(R¹)CONHZX⁺Y⁻ (2)

In the formulae (1) and (2), R¹ is a hydrogen atom or a methyl group, X⁺ is a cation moiety, and Y⁻ is an anion. Z represents an alkylene group having 1 to 3 carbon atoms.

The cation moiety (X⁺) constituting the reactive ionic liquid represented by the general formula (1) and/or (2) includes a quaternary ammonium group, an imidazolium group, a pyridinium group, a piperidinium group, a pyrrolidinium group, a pyrrole group, a quaternary phosphonium group, a trialkylsulfonium group, a pyrazolium group, a guanidium group, and the like. Among these, in particular, the quaternary ammonium group is a preferred embodiment for the electronic/optical applications because it is excellent in transparency. Further, since the quaternary ammonium group does not have an unsaturated bond other than the polymerizable functional group in the molecule, resulting in difficulty to inhibit the general radical polymerization reaction during ultraviolet (UV) curing, and is estimated to have a high curing property, such a quaternary ammonium group is suitable for the formation of an antistatic layer.

Specific examples of the quaternary ammonium group include a trimethylammonium group, a triethylammonium group, a tripropylammonium group, a methyldiethylammonium group, an ethyldimethylammonium group, a methyldipropylammonium group, a dimethylbenzylammonium group, a diethylbenzylammonium group, a methyldibenzylammonium group, an ethyldibenzylammonium group, and the like. In particular, the trimethylammonium group and the methylbenzylammonium group are preferred embodiments among others, in view of the fact that inexpensive industrial materials are easily obtained.

In the anion (moiety) (Y⁻) constituting the reactive ionic liquid represented by the general formula (1) and/or (2), examples of such anions include SCN⁻, BF₄⁻, PF₆⁻, NO₃⁻, CH₃COO⁻, CF₃COO⁻, CH₃SO₃⁻, CF₃SO₃—, (FSO₂)₂N⁻, (CF₃SO₂)₂N⁻, (CF₃SO₂)₃C⁻, ASF₆⁻, SbF₆⁻, NbF₆⁻, TaF₆⁻, F(HF)ₙ⁻, (CN)₂N⁻, C₄F₉SO₃⁻, (C₂F₅SO₂)₂N⁻, C₃F₇COO⁻, (CF₃SO₂)(CF₃CO)N, B (CN)₄⁻, C(CN)₃⁻, N(CN)₂⁻, CH₃OSO₃⁻, C₂H₅OSO₃⁻, C₄H₉OSO₃, C₆H₁₃OSO₃⁻, C₈H₁₇OSO₃⁻, p-toluenesulfonate anion, 2-(2-methoxyethyl)ethyl sulfate anion, (C₂F₅)₃ PF₃, and the like, and in particular, an anion component containing a fluorine atom (fluorine-containing anion) is preferable because an ionic liquid having a low melting point and an excellent antistatic property can be obtained. Note that it is desirable not to use a chlorine ion, a bromine ion or the like as an anion in view of corrosive properties thereof.

Particularly preferred combinations of the cation (moiety) and the anion (moiety) constituting the reactive ionic liquid represented by the general formula (1) and/or (2) include acryloylaminopropyltrimethylammonium bis(trifluoromethanesulfonyl)imide, methacryloylaminopropyltrimethylammonium bis(trifluoromethanesulfonyl)imide, acryloylaminopropyldimethylbenzylammonium bis(trifluoromethanesulfonyl)imide, acryloyloxyethyltrimethylammonium bis(trifluoromethanesulfonyl)imide, acryloyloxyethyldimethylbenzylammonium bis(trifluoromethanesulfonyl)imide, methacryloyloxyethyltrimethylammonium bis(trifluoromethanesulfonyl)imide, acryloylaminopropyltrimethylammonium bis(fluorosulfonyl)imide, methacryloylaminopropyltrimethylammonium bis(fluorosulfonyl)imide, acryloylaminopropyldimethylbenzylammonium bis(fluorosulfonyl)imide, acryloyloxyethyltrimethylammonium bis(fluorosulfonyl)imide, acryloyloxyethyldimethylbenzylammonium bis(fluorosulfonyl)imide, methacryloyloxyethyltrimethylammonium bis(fluorosulfonyl)imide, acryloylaminopropyltrimethylammonium trifluoromethanesulfonate, methacryloylaminopropyltrimethylammonium trifluoromethanesulfonate, acryloylaminopropyldimethylbenzylammonium trifluoromethanesulfonate, acryloyloxyethyltrimethylammonium trifluoromethanesulfonate, acryloyloxyethyldimethylbenzylammonium trifluoromethanesulfonate, methacryloyloxyethyltrimethylammonium trifluoromethanesulfonate, and the like.

In the total constituent units (total monomer units (components): 100% by mass) of the (meth)acrylic-based polymer, the reactive ionic liquid is contained in preferably 0.1 to 50% by mass, more preferably 1 to 30% by mass, and especially preferably 3 to 20% by mass. The blending ratio of the ionic liquid within the above range is preferable from the viewpoint of excellent antistatic properties, transparency, heat resistance (heat stability), and low staining property.

The general synthetic method for the reactive ionic liquid is not particularly limited as long as it allows production of the target ionic liquid. In general, there can be employed a quaternarization/ion-exchange method, direct quaternarization method, carbonate-based quaternarization method, hydroxylation method, acid ester method, complex formation method, neutralization method or the like, such as those described in the literatures “Ionic Liquids—Front Line of Development and Future Outlook—” [published by CMC Publishing Co., Ltd.], “Polymer, vol. 52, pp. 1469-1482 (2011)”, and “Most Advanced Material Systems, One Point 2, Ionic Liquid” [published by Kyoritsu Shuppan Co., Ltd.].

The other polymerizable monomer unit (component)) other than the reactive ionic liquid includes an alkyl(meth)acrylate having an alkyl group of 1 to 20 carbon atoms, and it is desirable that the pressure-sensitive adhesive layer is formed of a pressure-sensitive adhesive composition containing a (meth)acrylic-based polymer having the alkyl(meth)acrylate as a main component (a monomer unit). Note that the term “main component” means a monomer having the highest constitution ratio in the monomer units (components) to constitute the above (meth)acrylic-based polymer.

It is more preferable to use, as the monomer unit (component) constituting a (meth)acrylic-based polymer of the present invention, an alkyl(meth)acrylate having a linear or branched alkyl group of 1 to 20 carbon atoms and further preferable to use an alkyl(meth)acrylate having an alkyl group of 6 to 14 carbon atoms because the adhesive properties are obtained. One or two or more kinds of the alkyl(meth)acrylates may be used.

The (meth)acrylic-based polymer containing as a main component an alkyl(meth)acrylate having an alkyl group of 1 to 20 carbon atoms is one containing preferably 50 to 99% by mass, more preferably 60 to 98% by mass, further preferably 70 to 97% by mass, of an alkyl(meth)acrylate having an alkyl group of 1 to 20 carbon atoms as a monomer unit (component). From the viewpoint of imparting a moderate wettability and cohesive strength to the pressure-sensitive adhesive composition, it is preferable that the above monomer unit (component) be within the above range.

Specific examples of the alkyl(meth)acrylate having an alkyl group of 1 to 20 carbon atoms include, for example, methyl(meth)acrylate, ethyl(meth)acrylate, n-butyl(meth)acrylate, s-butyl(meth)acrylate, t-butyl(meth)acrylate, isobutyl(meth)acrylate, hexyl(meth)acrylate, 2-ethylhexyl(meth)acrylate, n-octyl(meth)acrylate, isooctyl(meth)acrylate, n-nonyl(meth)acrylate, isononyl(meth)acrylate, n-decyl(meth)acrylate, isodecyl(meth)acrylate, n-dodecyl(meth)acrylate, n-tridecyl(meth)acrylate, n-tetradecyl(meth)acrylate, and the like.

In particular, when the antistatic pressure-sensitive adhesive sheet of the present invention is used as a surface protective film, there are exemplified alkyl(meth)acrylates having an alkyl group of 6 to 14 carbon atoms, such as hexyl(meth)acrylate, 2-ethylhexyl(meth)acrylate, n-octyl(meth)acrylate, isooctyl(meth)acrylate, n-nonyl(meth)acrylate, isononyl(meth)acrylate, n-decyl(meth)acrylate, isodecyl(meth)acrylate, n-dodecyl(meth)acrylate, n-tridecyl(meth)acrylate, n-tetradecyl(meth)acrylate, and the like. By using the alkyl(meth)acrylate having an alkyl group of 6 to 14 carbon atoms, adhesive strength to an adherend can be easily controlled to be low, thereby to provide an excellent repeeling property.

In addition, other polymerizable monomer units (components) may be used as long as the effects of the present invention are not reduced, and such monomer units include polymerizable monomers for adjusting the glass transition temperature (Tg) or peeling property of the (meth)acrylic-based polymer in such a manner that Tg can be 0° C. or lower (generally −100° C. or higher) so that adhesive property can be easily balanced.

As the other polymerizable monomer used in the (meth)acrylic-based polymer, preferably used is a (meth)acrylate having a hydroxyl group (hydroxyl group-containing (meth)acrylic-based monomer) because crosslinking in particular can be easily controlled. Further, for the purpose of modifying cohesive strength, heat resistance, crosslinking, etc., other monomer component copolymerizable with the alkyl(meth)acrylate (copolymerizable monomer) may be, if necessary, contained in addition to the hydroxyl group-containing (meth)acrylic-based monomer. These monomer compounds may be used alone or as a mixture of two or more thereof.

By using the hydroxyl group-containing (meth)acrylic-based monomer, crosslinking of the pressure-sensitive adhesive composition can be easily controlled, resulting in easy control of the balance between improvement of wettability due to the fluidity, and reduction of the adhesive strength at the peeling process. Furthermore, unlike such a carboxyl group or a sulfonate group as described above that can act generally as a crosslinking site, a hydroxyl group can be suitably used also in terms of antistatic properties because the hydroxyl group has an appropriate interaction with an ionic compound (the alkali metal salt and ionic liquid described above) that can be added (combined) as a reactive ionic liquid and an antistatic agent. Examples of the hydroxyl group-containing monomer include 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, (4-hydroxymethylcyclohexyl)methyl acrylate, N-methylol(meth)acrylamide, vinyl alcohol, allyl alcohol, 2-hydroxyethyl vinyl ether, 4-hydroxybutyl vinyl ether, diethylene glycol monovinyl ether, etc.

In the case of containing the hydroxyl group-containing (meth)acrylic-based monomer, the hydroxyl group-containing (meth)acrylic-based monomer is contained in preferably 0 to 50% by mass, more preferably 1 to 40% by mass, and most preferably 2 to 30% by mass, based on the total constituent units (total monomer units (components): 100% by mass) of the (meth)acrylic-based polymer. When such a content is within the above range, it is easy to control the balance between wettability and cohesive strength of the pressure-sensitive adhesive composition, and this is desirable.

Further, specific examples of other copolymerizable monomer include:

carboxyl group-containing monomers, such as acrylic acid, methacrylic acid, carboxyethyl acrylate, carboxypentyl acrylate, itaconic acid, maleic acid, fumaric acid, crotonic acid, isocrotonic acid, etc;

acid anhydride group-containing monomers, such as maleic acid anhydride, itaconic acid anhydride, etc.;

sulfonic acid group-containing monomers, such as styrene sulfonic acid, allyl sulfonic acid, 2-(meth)acrylamide-2-methylpropanesulfonic acid, (meth)acrylamide propanesulfonic acid, sulfopropyl(meth)acrylate, (meth)acryloyloxy naphthalenesulfonic acid, etc.;

phosphate group-containing monomers, such as 2-hydroxyethyl acryloyl phosphate, etc.;

(N-substituted)amide-based monomers, such as (meth)acrylamide, N,N-dialkyl(meth)acrylamide (e.g. N,N-dimethyl(meth)acrylamide, N,N-diethyl(meth)acrylamide, N,N-dipropyl(meth)acrylamide, N,N-diisopropyl(meth)acrylamide, N,N-di(n-butyl)(meth)acrylamide, N,N-di(t-butyl)(meth)acrylamide, etc.), N-ethyl(meth)acrylamide, N-isopropyl(meth)acrylamide, N-butyl(meth)acrylamide, N-n-butyl(meth)acrylamide, N-methylol(meth)acrylamide, N-ethylol(meth)acrylamide, N-methylol propane(meth)acrylamide, N-methoxymethyl(meth)acrylamide, N-ethoxymethyl(meth)acrylamide, N-butoxymethyl(meth)acrylamide, N-acryloyl morpholine, etc.;

succinimide-based monomers, such as N-(meth)acryloyloxy methylene succinimide, N-(meth)acryloyl-6-oxyhexamethylene succinimide, N-(meth)acryloyl-8-oxyhexamethylenesuccinimide, etc.;

maleimide-based monomers, such as N-cyclohexylmaleimide, N-isopropyl maleimide, N-lauryl maleimide, N-phenyl maleimide etc.;

itaconimide-based monomers, such as N-methylitaconimide, N-ethylitaconimide, N-butylitaconimide, N-octylitaconimide, N-2-ethylhexylitaconimide, N-cyclohexylitaconimide, N-laurylitaconimide, etc.;

vinyl esters, such as vinyl acetate, vinyl propionate, etc.;

nitrogen-containing heterocyclic monomers, such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloylpyrrolidine, N-vinylmorpholine, N-vinyl-2-piperidone, N-vinyl-3-morpholinone, N-vinyl-2-caprolactam, N-vinyl-1,3-oxazin-2-one, N-vinyl-3,5-morpholinedione, N-vinyl pyrazole, N-vinyl isoxazole, N-vinyl thiazole, N-vinyl isothiazole, N-vinyl-pyridazine, etc.;

N-vinyl carboxylic acid amides;

lactam-based monomers, such as N-vinyl caprolactam, etc.;

cyanoacrylate monomers, such as acrylonitrile, methacrylonitrile, etc.;

aminoalkyl(meth)acrylate-based monomers, such as aminoethyl(meth)acrylate, N,N-dimethylaminoethyl(meth)acrylate, t-butylaminoethyl(meth)acrylate, etc.;

alkoxyalkyl(meth)acrylate-based monomers, such as methoxyethyl(meth)acrylate, ethoxyethyl(meth)acrylate, propoxyethyl(meth)acrylate, butoxyethyl(meth)acrylate, ethoxypropyl(meth)acrylate, etc.;

styrene-based monomers, such as styrene, α-methylstyrene, etc.;

epoxy group-containing acrylic-based monomers, such as glycidyl(meth)acrylate, etc.;

glycol-based acrylic ester monomers, such as polyethylene glycol(meth)acrylate, polypropylene glycol(meth)acrylate, methoxyethylene glycol(meth)acrylate, methoxypolypropylene glycol(meth)acrylate, etc.;

acrylic acid ester-based monomers having a heterocycle, halogen atom, silicon atom, or the like, such as tetrahydrofurfuryl(meth)acrylate, fluorine-containing (meth)acrylate, silicone-containing (meth)acrylate, etc.;

olefin-based monomers, such as isoprene, butadiene, isobutylene, etc.;

vinyl ether-based monomers, such as methyl vinyl ether, ethyl vinyl ether, etc.; vinyl esters, such as vinyl acetate, vinyl propionate, etc.;

aromatic vinyl compounds, such as vinyl toluene, styrene, etc.;

olefins or dienes, such as ethylene, butadiene, isoprene, isobutylene, etc.;

vinyl ethers, such as vinyl alkyl ether, etc.;

vinyl chloride;

sulfonic acid group-containing monomers, such as sodium vinyl sulfonate, etc.;

imide group-containing monomers, such as cyclohexyl maleimide, isopropyl maleimide etc.;

isocyanate group-containing monomers, such as 2-isocyanatoethyl(meth)acrylate, etc.;

acryloylmorpholine;

(meth)acrylic acid esters having an alicyclic hydrocarbon group, such as cyclopentyl(meth)acrylate, cyclohexyl(meth)acrylate, isobornyl(meth)acrylate, dicyclopentanyl(meth)acrylate, etc.;

(meth)acrylic acid esters having an aromatic hydrocarbon group, such as phenyl(meth)acrylate, phenoxyethyl(meth)acrylate, etc.; and

(meth)acrylic acid esters obtained from terpene compound derivative-derived alcohols. These copolymerizable monomers can be used alone or in combination of two or more thereof.

In the present invention, the other polymerizable monomer other than the hydroxyl group-containing (meth)acrylic-based monomer may be used alone or as a mixture of two or more thereof. The content of the other polymerizable monomer is preferably 0 to 30% by mass, more preferably 0 to 20% by mass, and especially preferably 0 to 10% by mass, based on the total constituent units of the (meth)acrylic-based polymer (total monomer units (components)). When the other polymerizable monomer is used in the above range, it is possible to appropriately control the repeeling property.

The (meth)acrylic-based polymer contained in the pressure-sensitive adhesive composition for use in the present invention has a weight average molecular weight (Mw) of preferably 100,000 to 5,000,000, more preferably 200,000 to 4,000,000, further preferably 300,000 to 3,000,000, especially preferably 300,000 to 1,000,000. When the weight average molecular weight is less than 100,000, there is a tendency such that an adhesive residue is generated due to reduction in the cohesive strength of the pressure-sensitive adhesive composition. On the other hand, when the weight average molecular weight exceeds 5,000,000, there is a tendency such that fluidity of the polymer is reduced and wetting on an adherend becomes insufficient, so that the adhesive strength may become short in some cases. The weight average molecular weight refers to a molecular weight obtained by measurement with GPC (gel permeation chromatography).

In addition, the glass transition temperature (Tg) of the (meth)acrylic-based polymer is preferably 0° C. or less, more preferably −10° C. or less, further preferably −40° C. or less, especially preferably −50° C. or less, and most preferably −60° C. or less (usually −100° C. or more). When the glass transition temperature is higher than 0° C., the polymer is less likely to flow, and for example, wettability to an adherend becomes insufficient in some cases, leading to an insufficient adhesive strength. In particular, by making the glass transition temperature to be −60° C. or less, it becomes possible to easily obtain a pressure-sensitive adhesive composition excellent in wettability to the adherend (polarizing plate etc.) and easy peeling property. Furthermore, the glass transition temperature of the (meth)acrylic-based polymer can be adjusted in the range described above by appropriately changing a monomer component and a composition ratio to be used.

When the (meth)acrylic-based polymer is a copolymer (for example, those contained in antistatic compositions or pressure-sensitive adhesive compositions) in the present invention, the glass transition temperatures (Tg) are values calculated based on the following equation (3) (Fox equation).

1/Tg=W₁/Tg₁+W₂/Tg₂+ . . . +Wₙ/Tgₙ (3)

[In the equation (3), Tg represents a glass transition temperature (unit: K) of the copolymer, Tgᵢ (i=1, 2, . . . n) represents a glass transition temperature (unit: K) of a homopolymer that is formed of a monomer i, and Wᵢ (i=1, 2, . . . n) represents a mass fraction of the monomer i in the whole monomer components.]

In addition, the glass transition temperatures Tgᵢ of the monomer i are nominal values described in documents (e.g. Polymer Handbook, Adhesive Handbook, etc.), catalogs, and the like.

Herein, the “glass transition temperature of a homopolymer that is formed” means the “glass transition temperature of a homopolymer formed of the monomer”, i.e., means the glass transition temperature (Tg) of a polymer that is formed only of a monomer (sometimes referred to as a “monomer X”) as a monomer component. Specifically, the glass transition temperature (Tg) is described in “Polymer Handbook” (3rd edition, John Wiley & Sons, Inc., 1989).

The glass transition temperature (Tg) of a homopolymer, which is not described in the aforementioned document, means a value obtained, for example, by the following measuring method.

That is, after 100 parts by mass of a monomer X, 0.2 parts by mass of 2,2′-azobisisobutyronitrile, and 200 parts by mass of ethyl acetate as a polymerization solvent are placed into a reactor provided with a thermometer, a stirrer, a nitrogen inlet pipe, and a reflux cooling pipe, they are stirred for 1 hour while nitrogen gas is being introduced. After the oxygen in the polymerization system has been removed in such a way, the mixture is heated to 63° C. and is allowed to react for 10 hours. Subsequently, the mixture is cooled to room temperature to obtain a homopolymer solution having a solid content of 33% by mass. Then, this homopolymer solution is casted and coated onto a release liner, which is then dried to produce a test sample having a thickness of approximately 2 mm (sheet-shaped homopolymer). Approximately 1 to 2 mg of this test sample are weighed into an aluminum open cell, and the Reversing Heat Flow (specific heat component) behaviors of the homopolymer are obtained by using a temperature-modulated DSC (trade name: “Q-2000”, manufactured by TA Instruments) under a nitrogen atmosphere of 50 ml/min and at a rate of temperature increase of 5° C./min.

With reference to JIS-K-7121, the temperature at the point where the straight line which is located in the vertical axis direction at the same distance from both the straight line obtained by extending the base line on the low temperature side of the obtained Reversing Heat Flow and the straight line obtained by extending the base line on the high temperature side thereof, and the curved line in a portion where the glass transition temperature is changed in a stepwise pattern intersect with each other is made to be the glass transition temperature (Tg), assuming that it is a homopolymer.

There is no particular limitation on the polymerization method that is used to obtain the (meth)acrylic-based polymer, and such polymerization can be carried out by known methods, such as solution polymerization, emulsion polymerization, bulk polymerization, suspension polymerization, and radiation-curable polymerization. When the antistatic pressure-sensitive adhesive sheet in an embodiment of the present invention is used for surface protecting application described later, the solution polymerization and emulsion polymerization are preferably employed from the viewpoint of productivity. The polymer obtained may be any of random copolymers, block copolymers, alternating copolymers, graft copolymers, and the like.

The pressure-sensitive adhesive layer in the present invention can be obtained preferably by crosslinking a pressure-sensitive adhesive composition containing the (meth)acrylic-based polymer and the like. By performing such crosslinking reaction while appropriately adjusting the constitution unit and constitution ratio of the (meth)acrylic-based polymer, and the selection and addition ratio of the crosslinking agent, it is possible to obtain a pressure-sensitive adhesive layer (antistatic pressure-sensitive adhesive sheet) that is more excellent in heat resistance.

Examples of the crosslinking agent used in the present invention include isocyanate compounds, epoxy compounds, melamine-based resins, aziridine derivatives, oxazoline crosslinking agents, silicone crosslinking agents, silane crosslinking agents, and metal chelate compounds. Among them, the isocyanate compounds and epoxy compounds are preferably employed mainly from the viewpoint of obtaining moderate cohesive strength, and the isocyanate compounds (isocyanate-based crosslinking agents) are particularly preferred. These compounds may be used alone or as a mixture of two or more thereof.

Examples of the isocyanate compound (isocyanate-based crosslinking agent) include, for example, lower aliphatic polyisocyanates, such as butylene diisocyanate, hexamethylene diisocyanate, etc.; alicyclic isocyanates, such as cyclopentylene diisocyanate, cyclohexylene diisocyanate, isophorone diisocyanate, etc.; aromatic diisocyanates, such as 2,4-tolylenediisocyanate, 4,4′-diphenylmethanediisocyanate, xylylene diisocyanate, etc.; isocyanate adducts, such as trimethylolpropane/tolylene diisocyanate trimer adduct (trade name: Coronate L, manufactured by Nippon Polyurethane Industry Co., Ltd.), trimethylolpropane/hexamethylene diisocyanate trimer adduct (trade name: Coronate HL, manufactured by Nippon Polyurethane Industry Co., Ltd.), an isocyanurate form of hexamethylene diisocyanate (trade name: Coronate HX, manufactured by Nippon Polyurethane Industry Co., Ltd.); and the like. Alternatively, compounds having one or more isocyanate groups and one or more unsaturated bonds in the molecule, specifically such as 2-isocyanatoethyl(meth)acylate, etc., can also be used as the isocyanate-based crosslinking agent. These compounds may be used alone or as a mixture of two or more thereof.

Examples of the epoxy compound include, for example, bisphenol A, epichlorohydrin type epoxy-based resin, ethylene glycidyl ether, polyethylene glycol diglycidyl ether, glycerine diglycidyl ether, glycerine triglycidyl ether, 1,6-hexanediol glycidyl ether, trimethylolpropane triglycidyl ether, diglycidyl aniline, diamineglycidylamine, N,N,N′,N′-tetraglycidyl-m-xylenediamine (trade name: TETRAD-X, manufactured by Mitsubishi Gas Chemical Co., Inc.), 1,3-bis(N,N-diglycidylaminomethyl)cyclohexane (trade name: TETRAD-C, manufactured by Mitsubishi Gas Chemical Co., Inc.), and the like. These compounds may be used alone or as a mixture of two or more thereof.

Examples of the melamine-based resin include hexamethylol melamine and the like. Further, examples of the aziridine derivative include commercially available products, such as “HDU”, “TAZM”, and “TAZO” (trade names) manufactured by Sogo Pharmaceutical Co., Ltd. These compounds may be used alone or as a mixture of two or more thereof.

In the metal chelate compound, examples of the metal component include aluminum, iron, tin, titanium, nickel, etc., and examples of the chelate component include acetylene, methyl acetoacetate, ethyl lactate, etc. These compounds may be used alone or as a mixture of two or more thereof.

The content (amount used) of the crosslinking agent to be used in the present invention is preferably 0.01 to 20 parts by mass, more preferably 0.5 to 15 parts by mass, and further preferably 0.5 to 10 parts by mass, based on 100 parts by mass of the (meth)acrylic-based polymer. If the content of such polymer is less than 0.01 parts by mass, there are sometimes the cases where the cohesive strength of the pressure-sensitive adhesive composition becomes smaller due to insufficient formation of crosslinks with a crosslinking agent, resulting in failure to obtain a sufficient heat resistance with a tendency to cause an adhesive residue. On the other hand, if the content is more than 20 parts by mass, there are sometimes the cases where the cohesive strength of the polymer becomes larger and the flowability thereof is deteriorated, and hence the wetting to an adherend becomes insufficient to make the adhesive strength insufficient.

The pressure-sensitive adhesive composition disclosed herein may further contain a crosslinking catalyst for effectively promoting any one of the aforementioned crosslinking reactions. As such a crosslinking catalyst, for example, a tin catalyst (in particular, dioctyltindilaurate) can be preferably used. The content (amount used) of the crosslinking catalyst (e.g., tin-based catalyst, such as dioctyltin dilaurate) is not particularly limited, but the amount may be, for example, within a range of 0.001 to 1 part by mass, based on 100 parts by mass of the (meth)acrylic-based polymer.

The pressure-sensitive adhesive composition disclosed herein may contain a compound that exhibits keto-enol tautomerism. For instance, in a pressure-sensitive adhesive composition containing a crosslinking agent or in a pressure-sensitive adhesive composition that may be used with a crosslinking agent incorporated thereinto, an embodiment including the compound that exhibits such keto-enol tautomerism can be preferably employed. This feature allows to suppress excessive viscosity increase or gelling of the pressure-sensitive adhesive composition after incorporating of the crosslinking agent thereinto, so that an effect of prolonging a pot life of the composition can be achieved. Incorporating a compound that exhibits keto-enol tautomerism is particularly meaningful in a case where at least an isocyanate compound is used as the crosslinking agent. The above technology can be preferably applied when the pressure-sensitive adhesive composition is in the form of an organic solvent solution or is in a solvent-free form.

Various β-dicarbonyl compounds can be used as the compound that exhibits keto-enoltautomerism. Specific examples thereof include, for example, β-diketones such as acetylacetone, 2,4-hexanedione, 3,5-heptanedione, 2-methylhexane-3,5-dione, 6-methylheptane-2,4-dione, 2,6-dimethylheptane-3,5-dione, etc.; acetoacetate esters such as methyl acetoacetate, ethyl acetoacetate, isopropylacetoacetate, tert-butylacetoacetate, etc.; propionyl acetate esters such as ethyl propionylacetate, isopropylpropionylacetate, tert-butylpropionylacetate, etc.; isobutyryl acetates such as ethyl isobutyrylacetate, isopropyl isobutyrylacetate, tert-butyl isobutyrylacetate, etc.; and malonic acid esters such as methyl malonate, ethyl malonate, etc. Preferred compounds among the foregoing are acetylacetone and acetoacetate esters. The compound that exhibits keto-enol tautomerism may be used alone or in combinations of two or more thereof.

A suitable content of the compound that exhibits keto-enol tautomerism can be, for example, 0.1 to 20 parts by mass, usually 0.5 to 15 parts by mass (for example, 1 to 10 parts by mass) per 100 parts by mass of the (meth)acrylic-based polymer. If the content of such compound is too low, a sufficient use effect is hardly exhibited in some cases. On the other hand, when the compound is used much in an amount more than necessary, it remains in the pressure-sensitive adhesive layer, resulting in reduction of cohesive strength.

In an embodiment of the present invention, a polyfunctional monomer having two or more radiation-reactive unsaturated bonds may be added as a crosslinking agent to the pressure-sensitive adhesive composition. In this case, the pressure-sensitive adhesive composition may be crosslinked by application of radiations. A single molecule of the polyfunctional monomer may have two or more radiation-reactive unsaturated bonds derived from one or two or more radiation-crosslinkable (curable) moieties such as vinyl, acryloyl, methacryloyl, and vinylbenzyl groups. The polyfunctional monomer that may be preferably used generally has 10 or less radiation-reactive unsaturated bonds. These compounds may be used alone or in a mixture of two or more.

Examples of the polyfunctinal monomer include ethylene glycol di(meth)acrylate, diethlene glycol di(meth)acrylate, tetraethylene glycol di(meth)acrylate, neopentyl glycol di(meth)acrylate, 1,6-hexanediol di(meth)acrylate, trimethylolpropane tri(meth)acrylate, pentaerythritol tri(meth)acrylate, dipentaerythritol hexa(meth)acrylate, divinylbenzene, and N,N′-methylenebisacrylamide.

The blending amount (amount used) of the polyfunctional monomer may be appropriately selected depending on the balance with the (meth)acrylic-based polymer to be crosslinked and further the use of the pressure sensitive adhesive sheet. In order to achieve sufficient heat resistance based on the cohesive strength of the acrylic-based pressure sensitive adhesive, 0.1 to 30 parts by mass of the polyfunctional monomer is, in general, preferably blended, based on 100 parts by mass of the (meth)acrylic-based polymer. In view of the flexibility and adhesive property, 10 parts by mass or less of the polyfunctional monomer is preferably blended, based on 100 parts by mass of the (meth)acrylic-based polymer.

Examples of radiation include ultraviolet ray, laser ray, α ray, β ray, γ ray, X-ray, and electron beam. From a viewpoint of controlling property and better handling property and a cost, ultraviolet ray is suitably used. More preferably, ultraviolet ray having a wavelength of 200 to 400 nm is used. Ultraviolet ray can be irradiated using an appropriate light source such as a high pressure mercury lamp, a micro-wave excitation-type lamp, and a chemical lamp. When ultraviolet ray is used as irradiation, a photopolymerization initiator is added to an acryl pressure-sensitive adhesive layer.

The photopolymerization initiator depends on a kind of a radiation-reactive component, and may be a substance which produces a radical or a cation by irradiating ultraviolet ray having an appropriately wavelength which can trigger the polymerization reaction.

Example of the photoradical polymerization initiator include benzoins such as benzoin, benzoin methyl ether, benzoin ethyl ether, methyl o-benzoylbenzoate-p-benzoin ethyl ether, benzoin isopropyl ether, and α-methylbenzoin, acetophenes such as benzylmethylketal, trichloroacetophenone, 2,2-diethoxyacetophenone, and 1-hydroxycyclohexyl phenyl ketone, propiophenones such as 2-hydroxy-2-methylpropiophenone, and 2-hydroxy-4′-isopropyl-2-methylpropiophenone, benzophenones such as benzophenone, methylbenzophenone, p-chlorobenzophenone, and p-dimethylaminobenzophenone, thioxanthons such as 2-chlorothioxanthon, 2-ethylthioxanthon, and 2-isopropylthioxanthon, acylphosphine oxides such as bis(2,4,6-trimethylbenzoyl)-phenylphosphine oxide, 2,4,6-trimethylbenzoyldiphenylphosphine oxide, and (2,4,6-trimethylbenzoyl)-(ethoxy)-phenylphosphine oxide, benzil, dibenzsuberone, and α-acyloximeether. These compounds may be used alone or in a mixture of two or more.

Examples of a photocation polymerization initiator include onium salts such as an aromatic diazonium salt, an aromatic iodonium salt, and an aromatic sulfonium salt, organometallic complexes such as an ion-allene complex. a titanocene complex, and an aryl silanol-aluminum complex, nitrobenzyl ester, sulfonic acid derivative, phosphoric acid ester, phenolsulfonic acid ester, diazonaphthoquinone, and N-hydroxymidosulfonate. These compounds may be used alone or in a mixture of two or more.

It is preferably that the photopolymerization initiator is blended usually in a range of 0.1 to 10 parts by weight, preferably 0.2 to 7 parts by weight relative to 100 parts by weight of a (meth)acryl-based polymer. It is preferred that the amount of the photopolymerization initiator is within the above range since it is easy to control a polymerization reaction and moderate molecular weight is obtained.

Further, it is also possible to use a photoinitiation polymerization assistant such as amines. Examples of the photoinitiation assistant include 2-dimethylaminoethyl benzoate, diemethylaminoacetophenone, p-dimethylaminobenzoic acid ethyl ester, and p-dimethylaminobenzoic acid isoamyl ester. Two or more kinds of the photopolymerization initiation assistants may be used. It is preferably that the polymerization initiation assistant is blended at 0.05 to 10 parts by weight, further 0.1 to 7 parts by weight relative to 100 parts by weight a (meth)acryl-based polymer. It is preferred that the amount of the photopolymerization initiator is within the above range since it is easy to control a polymerization reaction and moderate molecular weight is obtained.

When a photopolymerization initiator as an arbitrary component is added as described above, a pressure-sensitive adhesive layer can be obtained by coating the pressure-sensitive adhesive composition directly on an adherend (an object to be protected), or coating on one side or both sides of a supporting substrate, and performing light irradiation. Usually, a pressure-sensitive adhesive layer is used by photopolymerization by irradiating with ultraviolet ray having an irradiance of 1 to 200 mW/cm² at a wavelength of 300 to 400 nm, at an expose dose of around 200 to 4000 mJ/cm².

Further, the pressure sensitive adhesive composition may contain other known additives, for example, a conductive agent (antistatic agent), a powder of a coloring agent, a pigment, or the like, a surfactant, a plasticizer, a tackifier, a low-molecular-weight polymer, a surface lubricant, a leveling agent, an antioxidant, a corrosion inhibitor, a light stabilizer, an ultraviolet absorber, a polymerization inhibitor, a silane coupling agent, an inorganic or an organic filler, a metal powder, a particulate or foil material, and others, which may be added as appropriate depending on the intended use. It is a particularly preferred embodiment to use an ionic compound such as an alkali metal salt and an ionic liquid (including the reactive ionic liquid described above) as the conductive agent (antistatic agent).

The pressure sensitive adhesive sheet of the present invention is produced by forming the pressure sensitive adhesive layer on an antistatic substrate film. In this process, the pressure sensitive adhesive composition is generally crosslinked after the application of the pressure sensitive adhesive composition. Alternatively, however, the pressure sensitive adhesive layer formed by the pressure sensitive adhesive composition after being crosslinked may be transferred to an antistatic substrate film.

Any method may be used to form the pressure-sensitive adhesive layer on the antistatic substrate film. For example, the pressure-sensitive adhesive composition (solution) is applied to the antistatic substrate film, and the polymerization solvent or the like is removed by drying so that the pressure-sensitive adhesive layer is formed on the antistatic substrate film. Thereafter, the pressure-sensitive adhesive layer may be subjected to curing for the purpose of controlling a component transfer from the pressure-sensitive adhesive layer or controlling the crosslinking reaction. When the pressure-sensitive adhesive composition (solution) is applied to an antistatic substrate film to form an antistatic pressure-sensitive adhesive sheet, one or more solvents other than the polymerization solvent may be newly added to the pressure-sensitive adhesive composition such that the composition can be uniformly applied to the antistatic substrate film.

When the pressure-sensitive adhesive sheet of the present invention is manufactured, known methods which have been used in manufacturing pressure-sensitive adhesive tapes may be used to form the pressure-sensitive adhesive layer. Specific examples thereof include roll coating, gravure coating, reverse coating, roll blush, spray coating, air knife coating, and extrusion coating using a die coater.

The pressure-sensitive adhesive sheet of the present invention is usually formed such that the thickness of the pressure-sensitive adhesive layer is 3 to 100 μm, preferably about 5 to 50 μm, further preferably 10 to 30 μm. If the thickness of the pressure-sensitive adhesive layer is within the above range, a moderate balance between repeeling property and adherability is easily obtained, and this is desirable.

If necessary, a separator can be laminated on a surface of the pressure-sensitive adhesive sheet (surface protective film) of the present invention for the purpose of protecting the surface of a pressure-sensitive adhesive layer.

As a material constituting the separator, there are a paper and a plastic film, and a plastic film is suitably used from the viewpoint of excellent surface smoothness. The film is not particularly limited as long as it is a film capable of protecting the pressure-sensitive adhesive layer. Examples of the film include, for example, a polyethylene film, a polypropylene film, a polybutene film, a polybutadiene film, a polymethylpentene film, a polyvinylchloride film, a vinyl chloride copolymer film, a polyethyleneterephthalate film, a polybutyleneterephthalate film, a polyurethane film, an ethylene-vinylacetate copolymer film, etc.

The thickness of the separator is within a range of usually 5 to 200 μm, preferably about 10 to 100 μm, and further preferably about 15 to 50 μm. When the thickness is within the above range, it is preferable because the workability in laminating to the pressure-sensitive adhesive layer and that in peeling off therefrom are both excellent. The separator may also be subjected, if necessary, to a mold release treatment and an antifouling treatment by a silicone mold release agent, a fluorine mold release agent, a long-chain alkyl mold release agent, a fatty acid amide mold release agent, or a silica powder, or to an antistatic treatment, such as coating type treatment, kneading type treatment, deposition type treatment, and the like.

### <Antistatic Substrate Film>

The antistatic substrate film constituting the pressure-sensitive adhesive sheet of the present invention is not particularly limited, but a known one can be used for such purpose. The substrate film is preferably a plastic film having heat resistance, solvent resistance and flexibility. When the antistatic substrate film has flexibility, the pressure-sensitive adhesive composition may be applied using a roll coater or the like, and the film may be wound into a roll shape.

The plastic film is not particularly limited as far as it can be formed into a sheet or a film, and examples include a polyolefin film such as polyethylene, polypropylene, poly-1-butene, poly-4-methyl-1-pentene, an ethylene.propylene copolymer, an ethylene.1-butene copolymer, an ethylene.vinyl acetate copolymer, an ethylene.ethyl acrylate copolymer, and an ethylene.vinyl alcohol copolymer, a polyester film such as polyethylene terephthalate, polyethylene naphthalate, and polybutylene terephthalate, a polyacrylate film, a polyurethane film, a polystyrene film, a polyamide film such as nylon 6, nylon 6,6, and partially a romaticpolyamide, a polyvinyl chloride film, a vinyl chloride copolymer film, a polyvinylidene chloride film, and a polycarbonate film.

The antistatic substrate film may be subjected, if necessary, to a releasing treatment or an antifouling treatment with silicone-based, fluorine-based, long chain alkyl-based, or fatty acid amide-based releasing agent, or a silica powder, or an easy adhesion treatment such as acid treatment, alkali treatment, primer treatment, corona treatment, plasma treatment, ultraviolet ray treatment, etc.

The antistatic substrate films are preferably those to which an antistatic treatment such as coating-type, kneading-type, or deposition-type antistatic treatment is applied. It is more preferable to have an antistatic layer on at least one side of the substrate layer in the antistatic substrate film, and such antistatic layer is further preferably a layer containing at least one kind selected from the group consisting of a metal film, a conductive filler, an electronically conductive polymer, and an ion conductive polymer.

In particular, when the pressure-sensitive adhesive sheet of the present invention is used as a surface protecting film, it is very useful as an antistatic surface protecting film in the technical field associated with optical/electronic components in which electrification and staining cause a particularly serious problem. This is because the electrification of the surface protecting film itself is effectively suppressed at the time of peeling off, and a more excellent antistatic ability to an adherend (an object to be protected) is obtained.

The method of providing an antistatic layer on at least one side of the substrate layer includes a method of coating an antistatic resin composed of an antistatic agent (conductive agent) and a resin component, or a conductive resin containing a conductive polymer (electronically conductive polymer), an ion conductive polymer, a conductive substance (conductive filler, metal, etc.), a method of depositing or plating (metal film, etc.) a conductive substance, and the like.

Examples of the antistatic agent (conductive agent) include, for example, a cation-type antistatic agent having a cationic functional group, such as a quaternary ammonium salt, a pyridinium salt, and a primary, secondary or tertiary amino group; an anion-type antistatic agent having an anionic functional group, such as a sulfonic acid salt, a sulfuric acid ester salt, a phosphonic acid salt, and a phosphoric ester salt; an amphoteric-type antistatic agent, such as alkylbetain and a derivative thereof, imidazoline and a derivative thereof, and alanine and a derivative thereof; a nonion-type antistatic agent, such as an aminoalcohol and a derivative thereof, glycerin and a derivative thereof, and polyethylene glycol and a derivative thereof; and an ion conductive polymer obtained by polymerizing or copolymerizing a monomer having the aforementioned cation-type, anion-type, or amphoteric-type ion conductive group (e.g. a polymer containing a reactive ionic liquid as a monomer unit). The compounds may be used alone, or two or more kinds may be used by mixing.

Specifically, examples of the cation-type antistatic agent include a (meth)acrylate copolymer having a quaternary ammonium group such as an alkyl trimethylammonium salt, acyloylamidopropyltrimethylammonium methosulfate, an alkylbenzylmethylammonium salt, acyl choline chloride, and polydimethylaminoethyl methacrylate, a styrene copolymer having a quaternary ammonium group such as polyvinylbenzyltrimethylammonium chloride, and a diallylamine copolymer having a quaternary ammonium group such as polydiallyldimethylammonium chloride. The compounds may be used alone, or two or more kinds may be used by mixing.

Examples of the anion-type antistatic agent include an alkyl sulfonic acid salt, an alkylbenzenesulfonic acid salt, an alkyl sulfate ester salt, an alkyl ethoxy sulfate ester salt, an alkyl phosphate ester salt, and a sulfonic acid group-containing styrene copolymer. These compounds may be used alone, or two or more kinds may be used by mixing.

Examples of the amphoteric-type antistatic agent include alkylbetain, alkylimidazoliumbetain, and carbobetaingrafted copolymer. These compounds may be used alone, or two or more kinds may be used by mixing.

Examples of the nonion-type antistatic agent include fatty acid alkylolamide, di(2-hydroxyethyl)alkylamine, polyoxyethylenealkylamine, fatty acid glycerin ester, polyoxyethylene glycol fatty acid ester, sorbitan fatty acid ester, polyoxysorbitan fatty acid ester, polyoxyethylene alkyl phenyl ether, polyoxyethylene alkyl ether, polyethylene glycol, polyoxyethylenediamine, a copolymer consisting of polyether, polyester and polyamide, and methoxypolyethyleneglycol(meth)acrylate. These compounds may be used alone, or two or more kinds may be used by mixing.

Examples of the conductive polymer (electronically conductive polymer) include, for example, polyaniline, polypyrrole, polythiophene, poly(ethylenedioxythiophene) (abbreviated as PEDOT), poly(ethylenedioxythiophene)/polystyrene sulfonate (abbreviated as PEDOT/PSS), and the like. These compounds may be used alone or as a mixture of two or more thereof. In particular, the poly(ethylenedioxythiophene)/polystyrene sulfonate (abbreviated as PEDOT/PSS) is preferable from the viewpoint of its antistatic property and transparency.

The ion conductive polymer includes, for example, a polymer containing a reactive ionic liquid as a monomer unit. Specific examples of such a polymer include, for example, a copolymer of a reactive ionic liquid and a hydroxyl group-containing monomer; a copolymer of a reactive ionic liquid and a carboxyl group-containing monomer; a copolymer of a reactive ionic liquid and a nitrogen-containing heterocycle-based monomer; a copolymer of a reactive ionic liquid and an (N-substituted)amide-based monomer; a copolymer of a reactive ionic liquid and a (meth)acrylic-based alkyl ester having an alkyl group of 1 to 20 carbon atoms; a copolymer of a reactive ionic liquid and polyethylene glycol(meth)acrylate, and the like. These compounds may be used alone or as a mixture of two or more thereof. In the case of application to the substrate layer, a crosslinking agent may be contained as needed and for example, the crosslinking agent usable in the above pressure-sensitive adhesive layer can be also used here. Specific examples of the crosslinking agent used include an isocyanate compound, an epoxy compound, a melamine-based resin, an aziridine derivative, an oxazoline crosslinking agent, silicone crosslinking agent, a silane crosslinking agent, a metal chelate compound, and a polyfunctional monomer having two or more radiation reactive unsaturated bonds. Among them, from the viewpoint of mainly obtaining a moderate cohesive strength, the isocyanate compound and epoxy compound are preferably used and the isocyanate compound (isocyanate-based crosslinking agent) is particularly preferably used. These compounds may be used alone or as a mixture of two or more thereof.

Examples of the conductive substance (conductive filler, metal, etc.) include tin oxide, antimony oxide, indium oxide, cadmiumoxide, titaniumoxide, zinc oxide, indium, tin, antimony, gold, silver, copper, aluminum, nickel, chromium, titanium, iron, cobalt, copper iodide, and an alloy or a mixture thereof.

As the resin component (antistatic composition) used for the antistatic resin and the conductive resin, there is employed a general-purpose resin such as polyester, acryl, polyvinyl, urethane, melamine and epoxy. In the case of a polymer-type antistatic agent, it is not necessary to contain a resin component. In addition, the resin component may contain a crosslinking agent as needed, and, for example, a crosslinking agent usable in the pressure-sensitive adhesive layer described above can be used.

The resin component (antistatic composition) can further contain a compound that exhibits keto-enol tautomerism. It is possible to suppress gelation and an excessive increase of viscosity after the blending of the crosslinking agent, as well as to realize an effect of extending the pot life of the antistatic composition.

Further, the antistatic composition may contain other known additives, including, for example, a powder of a coloring agent, a pigment or the like, a surfactant, a plasticizer, a tackifier, a low-molecular-weight polymer, a surface lubricant, a leveling agent, an antioxidant, a corrosion inhibitor, a light stabilizer, an ultraviolet absorber, a polymerization initiator, a polymerization inhibitor, a silane coupling agent, an inorganic or organic filler, a metal powder, a particulate or foil material, and others, which may be added as appropriate depending on the intended use.

The antistatic layer can be formed, for example, by a method in which the aforementioned antistatic resin, conductive polymer, and conductive resin are diluted with a solvent, such as an organic solvent or water, and the solution is coated on a substrate layer (plastic film) and dried. Further, it is possible to preferably employ a method of performing a hardening processing (heat treatment, ultraviolet treatment, etc.) as needed.

As the organic solvents to be used for forming the antistatic layer, it is possible to use, for example, one or two or more solvents selected from esters such as ethyl acetate, butyl acetate, 2-hydroxyethyl acetate, etc.; ketones such as methyl ethyl ketone, acetone, cyclohexanone, methyl isobutyl ketone, diethyl ketone, methyl-n-propyl ketone, acetylacetone, etc.; cyclic ethers such as tetrahydrofuran (THF), dioxane, etc.; aliphatic or alicyclic hydrocarbons such as n-hexane, cyclohexane, etc.; aromatic hydrocarbons such as toluene, xylene, etc.; aliphatic or alicyclic alcohols such as methanol, ethanol, n-propanol, isopropanol, cyclohexanol, etc.; glycol ethers such as ethylene glycol monomethyl ether, ethylene glycol monoethyl ether, diethylene glycol monoethyl ether, etc.; glycol ether acetates such as diethylene glycol monomethyl ether acetate, diethylene glycol monoethyl ether acetate, etc.; and the like.

As a coating method in formation of the antistatic layer, the known coating method is appropriately used, and examples include roll coating, gravure coating, reverse coating, roll brushing, spray coating, and air knife coating methods, and an immersing and curtain coating method.

The thickness of each of the antistatic resin layer, the conductive polymer layer, and the conductive resin layer, is usually within a range of approximately 0.002 to 5 μm, preferably within a range of approximately 0.01 to 1 μm.

Examples of a method of depositing or plating an electrically conductive substance include vacuum deposition, sputtering, ion plating, chemical deposition, spray pyrolysis, chemical plating, and electric plating methods.

The thickness of the conductive substance layer is usually within a range of 2 nm to 1000 nm, preferably within a range of 5 nm to 500 nm.

A method of kneading a kneading type antistatic agent is not particularly limited, as far as the antistatic agent can be uniformly mixed into the resin (e.g. polyethylene terephthalate, etc. as the raw material for plastic films) to be used in the antistatic substrate film (substrate film); and for example, a heating roll, a Banbury mixer, a pressurizing kneader, or a twin screw kneader can be used. The blending amount (amount used) of the antistatic agent is equal to or less than 20% by mass, and preferably within a range of 0.05% to 10% by mass, based on the total weight of the substrate film. It is desirable that such amount be within the above range because there is a small possibility to spoil the heat resistance, solvent resistance, and flexibility of the substrate film.

The thickness (the total thickness of both layers in the case where the antistatic substrate film is composed of the antistatic layer and the substrate layer) of the antistatic substrate film constituting the pressure-sensitive adhesive sheet of the present invention is usually 5 to 300 μm, preferably about 10 to 200 μm. When the thickness of the substrate film is within the above range, both of laminating workability to an adherend and peeling workability from the adherend are excellent, and thus this is desirable.

Since the antistatic pressure-sensitive adhesive sheet of the present invention has a pressure-sensitive adhesive layer excellent in antistatic properties, it can be used for surface protection as well as for electronic components production and a shipment process. In such applications, there is a risk of occurrence of adhesion of dirt and dust, as well as destruction of electronic components due to static electricity, but the pressure-sensitive adhesive sheet of the present invention is useful because it can suppress such a risk.

The pressure-sensitive adhesive sheet of the present invention is laminated to an optical film and then can be used as an optical film with an antistatic pressure-sensitive adhesive sheet. By laminating the pressure-sensitive adhesive sheet to the optical film, it is possible to protect the surface of the optical film, and this is useful. In particular, since the pressure-sensitive adhesive sheet can be applied to plastic products which are easy to generate static electricity, such a sheet is very useful for antistatic purpose in the technical field associated with optical/electronic components in which electrification causes a particularly serious problem.

### EXAMPLES

Hereinafter, several Examples relating to the present invention will be described, but these Examples are not intended to limit the present invention to such specific Examples. In addition, “parts” and “%” in the following description are expressed on a mass basis, unless otherwise noted.

### <Preparation of Reactive Ionic Liquid (DMAEA-TFSI)>

To a 1 L-three necked flask were added 100 parts of 79% aqueous solution of (2-acryloyloxy)ethyltrimethylammonium chloride (DMAEA-Q, manufactured by Kohjin Co., Ltd.) and then, with stirring under heating at 60° C., a solution obtained by diluting 114 parts of potassium bis(trifluoromethane-sulfonyl)imide in 80 parts of ion-exchange water. After 2 hours, the oily lower layer was taken out from the two separated layers, washed 3 times with ion-exchange water, and a trace amount of remaining water was removed under reduced pressure to obtain 2-(acryloyloxy)ethyltrimethylammonium bis(trifluoromethane-sulfonyl)imide (DMAEA-TFSI).

### <Preparation of Reactive Ionic Liquid (DMAPAA-TFSI)>

To a 1 L-three necked flask were added 100 parts of 75% aqueous solution of (3-acrylamidopropyl)trimethylammonium chloride (DMAPAA-Q, manufactured by Kohjin Co., Ltd.) and then, with stirring under heating at 60° C., a solution obtained by diluting 116 parts of potassium bis(trifluoromethane-sulfonyl)imide in 80 parts of ion exchange water. After 2 hours, the oily lower layer was taken out from the two separated layers, washed 3 times with ion-exchange water, and a trace amount of remaining water was removed under reduced pressure to obtain (3-acrylamidopropyl)trimethylammonium bis(trifluoromethane-sulfonyl)imide (DMAPAA-TFSI).

### <Preparation of (Meth)Acrylic-Based Polymer (A) for Pressure-Sensitive Adhesive Layer>

To a four-necked flask equipped with a stirring blade, a thermometer, a nitrogen gas inlet, a condenser and an addition funnel were added 233 parts of ethyl acetate, 85 parts of 2-ethylhexyl acrylate (2EHA), 10 parts of DMAEA-TFSI, and 5 parts of 2-hydroxyethyl acrylate (HEA). Then, the mixture was stirred at 60° C. for 1 hour under a nitrogen atmosphere and 0.2 parts of 2,2′-azobisisobutyronitrile as a polymerization initiator was added thereto. The resulting mixture was allowed to react at 60° C. for 4 hours and then at 70° C. for 3 hours.

### <Preparation of (Meth)Acrylic-Based Polymer (B) for Pressure-Sensitive Adhesive Layer>

Into a four-necked flask equipped with a stirring blade, a thermometer, a nitrogen gas inlet, a condenser and an addition funnel were added 233 parts of ethyl acetate, 85 parts by weight of 2-ethylhexyl acrylate (2EHA), 10 parts of DMAPAA-TFSI, and 5 parts of 2-hydroxyethyl acrylate (HEA). Then, the mixture was stirred at 60° C. for 1 hour under a nitrogen atmosphere and 0.2 parts of 2,2′-azobisisobutyronitrile as a polymerization initiator was added thereto. The resulting mixture was allowed to react at 60° C. for 4 hours and then at 70° C. for 3 hours.

### <Preparation of (Meth)Acrylic-Based Polymer (C) for Antistatic Layer (Ion Conductive Polymer)>

To a four-necked flask equipped with a stirring blade, a thermometer, a nitrogen gas inlet, a condenser, and an addition funnel were added 400 parts of methyl ethyl ketone, 95 parts of DMAEA-TFSI, and 5 parts of 2-hydroxyethylmethacrylate (HEMA). Then, the mixture was stirred at 70° C. for 1 hour under a nitrogen atmosphere and 0.2 parts of 2,2′-azobisisobutyronitrile as a thermal polymerization initiator was added thereto. The resulting mixture was allowed to react at 70° C. for 4 hours and then at 80° C. for 4 hours. After that, 0.1 parts of 2,2′-azobisisobutyronitrile as a polymerization initiator was added thereto and the mixture was allowed to react at 80° C. for 1 hour. After further addition of 0.2 parts of 2,2′-azobisisobutyronitrile as a polymerization initiator, the resulting mixture was allowed to react at 70° C. for 4 hours and then at 80° C. for 4 hours.

### <Preparation of (Meth)Acrylic-Based Polymer (D) for Pressure-Sensitive Adhesive Layer>

To a four-necked flask equipped with a stirring blade, a thermometer, a nitrogen gas inlet, a condenser, and an addition funnel were added 200 parts of 2-ethylhexyl acrylate (2EHA), 8 parts of 2-hydroxyethyl acrylate (HEA), 0.4 parts of 2,2′-azobisisobutyronitrile as a polymerization initiator, and 312 parts of ethyl acetate, and nitrogen gas was introduced thereto with gentle stirring. Polymerization reaction was carried out for 6 hours while maintaining the liquid temperature in the flask at around 65° C., thereby to prepare a (meth)acrylic-based polymer (D) solution (40% by mass). The glass transition temperature (Tg) of the (meth)acrylic-based polymer (D) solution, calculated from the Fox equation, was −68° C. and the weight average molecular weight was 550,000.

### (Preparation of Antistatic Resin Composition Solution (1)>

A toluene solution (binder solution (E)) containing an acrylic-based polymer (binder polymer (F)) as a binder in 5% was prepared.

The above binder solution (E) was produced in the following way. That is, 25 parts of toluene were charged into a reactor and the temperature in the reactor was raised to 105° C. Then, a solution of a mixture of 30 parts of methyl methacrylate (MMA), 10 parts of n-butyl acrylate (BA), 5 parts of cyclohexyl methacrylate (CHMA), and 0.2 parts of 2,2′-azobisisobutyronitrile (AIBN) as a polymerization initiator was dropwise added continuously to the reactor over a period of 2 hours. After completion of the dropwise addition, the temperature in the reactor was adjusted to 110 to 115° C. and kept at the same temperature for 3 hours to carry out the copolymerization reaction. After 3 hours, a mixture of 4 parts of toluene and 0.1 parts of AIBN was dropwise added to the reactor and kept at the same temperature for 1 hour. Subsequently, the temperature of the reactor was cooled to 90° C. and the reaction mixture was diluted by the addition of toluene so that non-volatile content (NV) was adjusted to 5%. Two parts of the binder solution (E) (containing 0.1 parts of the binder polymer (F)) and 40 parts of ethylene glycol monoethyl ether were added to a 150 ml volume beaker and mixed with stirring. To the beaker were further added 1.2 parts of an aqueous conductive polymer solution (C1) of an NV of 4.0% containing polyethylenedioxythiophene (PEDOT) and polystyrene sulfonate (PSS), 55 parts of ethylene glycol monomethyl ether, 0.05 parts of polyether-modified polydimethylsiloxane-based leveling agent (trade name “BYK-300”, NV 52%, manufactured by BYK Chemie GmbH), and a melamine-based crosslinking agent, and the mixture was stirred for about 20 minutes to mix well. Thus, an antistatic resin composition solution (1) was prepared that had an NV value of 0.18% and contained 50 parts of a conductive polymer, and 30 parts of a lubricant (both based on the solid content) and further a melamine-based crosslinking agent based on 100 parts of the binder polymer (F) (base resin).

### <Production of Antistatic-Treated Film (Antistatic Substrate Film)>

The antistatic resin composition solution (1) was applied to a polyethylene terephthalate (PET) film (38 μm in thickness) with a Meyer bar and dried at 130° C. for 1 minute to remove the solvent, so that an antistatic layer (0.03 μm in thickness) was formed to prepare an antistatic-treated film (1).

### Example 1

### Preparation of Pressure-Sensitive Adhesive Composition

The (meth)acrylic-based polymer (A) solution (30% by mass) was diluted to 20% by mass with ethyl acetate. To 500 parts (100 parts as the polymer) of the resulting diluted solution were added 5.3 parts of Coronate L (trimethylolpropane/tolylene diisocyanate trimer adduct, solid content of 75% by mass, in ethyl acetate solution, manufactured by Nippon Polyurethane Industry Co., Ltd.) as a crosslinking agent, and 3.0 parts of dioctyltin dilaurate (1% by mass ethyl acetate solution) as a crosslinking catalyst, and they were mixed with stirring at 25° C. for about 5 minutes, thereby to prepare an acrylic-based pressure-sensitive adhesive solution (1).

### (Production of Pressure-Sensitive Adhesive Sheet)

The acrylic-based pressure-sensitive adhesive solution (1) was applied to the antistatic-treated surface (antistatic layer side) of the antistatic-treated film (1), and heated at 130° C. for 2 minutes to form a pressure-sensitive adhesive layer having a thickness of 20 μm. Subsequently, a polyethylene terephthalate film (separator) having a thickness of 25 μm, on one side of which a silicone treatment had been performed, was bonded on the silicone-treated surface to the surface of the pressure-sensitive adhesive layer to prepare a pressure-sensitive adhesive sheet (1).

### Example 2

### Preparation of Pressure-Sensitive Adhesive Composition

An acrylic-based pressure-sensitive adhesive solution (2) was prepared in the same way as in Example 1, except that the (meth)acrylic-based polymer (B) solution (30% by mass) was used in place of the (meth)acrylic-basedpolymer (A) solution (30% by mass).

### (Production of Pressure-Sensitive Adhesive Sheet)

A pressure-sensitive adhesive sheet (2) was produced in the same way as in Example 1, except that the acrylic-based pressure-sensitive adhesive solution (2) was used in place of the acrylic-based pressure-sensitive adhesive solution (1).

### Example 3

### Production of Pressure-Sensitive Adhesive Sheet

A pressure-sensitive adhesive sheet (3) was produced in the same way as in Example 1, except that an aluminum deposited polyethylene terephthalate (PET) film (thickness: 50 μm) was used in place of the antistatic-treated film (1).

### Example 4

### Production of Pressure-Sensitive Adhesive Sheet

A pressure-sensitive adhesive sheet (4) was produced in the same way as in Example 2, except that an aluminum deposited polyethylene terephthalate (PET) film (thickness: 50 μm) was used in place of the antistatic-treated film (1).

### Example 5

### Preparation of Antistatic Resin Composition Solution (2)

The (meth)acrylic-based polymer (C) solution (20% by mass) was diluted to 4.2% by mass with methyl ethyl ketone. To 2381 parts (100 parts as the polymer) of the resulting diluted solution were added 4.0 parts of Coronate L (trimethylolpropane/tolylene diisocyanate trimer adduct, solid content of 75% by mass, in ethyl acetate solution, manufactured by Nippon Polyurethane Industry Co., Ltd.) as a crosslinking agent, and 3.0 parts of dioctyltin dilaurate (1% by mass ethyl acetate solution) as a crosslinking catalyst, and they were mixed with stirring at 25° C. for about 5 minutes, thereby to prepare an antistatic resin composition solution (2).

### (Production of Antistatic-Treated Film)

An antistatic-treated film (2) was produced in the same way as in Example 1, except that the antistatic resin composition solution (2) having an antistatic layer with a thickness of 0.5 μm was used in place of the antistatic resin composition solution (1).

### (Production of Pressure-Sensitive Adhesive Sheet)

A pressure-sensitive adhesive sheet (5) was produced in the same way as in Example 1, except that the antistatic-treated film (2) was used in place of the antistatic-treated film (1).

### Example 6

### Production of Pressure-Sensitive Adhesive Sheet

A pressure-sensitive adhesive sheet (6) was produced in the same way as in Example 2, except that the antistatic-treated film (2) was used in place of the antistatic-treated film (1).

### Comparative Example 1

### Preparation of Pressure-Sensitive Adhesive Composition

The (meth)acrylic-based polymer (D) solution (40% by mass) was diluted to 20% by mass with ethyl acetate. To 500 parts (100 parts as the polymer) of the resulting diluted solution were added 5.3 parts of Coronate L (trimethylolpropane/tolylene diisocyanate trimer adduct, solid content of 75% by mass, in ethyl acetate solution, manufactured by Nippon Polyurethane Industry Co., Ltd.) as a crosslinking agent, and 3.0 parts of dioctyltin dilaurate (1% by mass ethyl acetate solution) as a crosslinking catalyst, and they were mixed with stirring at 25° C. for about 5 minutes, thereby to prepare an acrylic pressure-sensitive adhesive solution (3).

### (Production of Pressure-Sensitive Adhesive Sheet)

A pressure-sensitive adhesive sheet (7) was produced in the same way as in Example 1, except that the acrylic-based pressure-sensitive adhesive solution (3) was used in place of the acrylic-based pressure-sensitive adhesive solution (1).

### Comparative Example 2

The (meth)acrylic-based polymer (D) solution (40% by mass) was diluted to 20% by mass with ethyl acetate. To 500 parts (100 parts as the acrylic-based polymer (D)) of the resulting diluted solution were added 0.06 parts of a lithium salt, lithium bis(trifluoromethanesulfonyl) imide as an antistatic agent, 0.5 parts of a silicone compound having a polyether chain (“polyether compound” in Table 1, KF6004, manufactured by Shin-Etsu Chemical Co., Ltd.), 3.3 parts of Coronate L (trimethylolpropane/tolylene diisocyanate trimer adduct, solid content of 75% by mass, in ethyl acetate solution, manufactured by Nippon Polyurethane Industry Co., Ltd.) as a crosslinking agent, and 3.0 parts of dioctyltin dilaurate (1% by mass ethyl acetate solution) as a crosslinking catalyst, and they were mixed with stirring at 25° C. for about 5 minutes, thereby to prepare an acrylic-based pressure-sensitive adhesive solution (4).

### (Production of Pressure-Sensitive Adhesive Sheet)

A pressure-sensitive adhesive sheet (8) was produced in the same way as in Example 1, except that the acrylic-based pressure-sensitive adhesive solution (3) was used in place of the acrylic-based pressure-sensitive adhesive solution (1), the thickness of the pressure-sensitive adhesive layer was changed to 15 μm, and a polyethylene terephthalate (PET) film (38 in thickness) was used in place of the antistatic-treated film (1).

### <Measurement of Weight Average Molecular Weight (Mw)>

The weight average molecular weight (Mw) was measured by using a GPC apparatus (HLC-8220GPC, manufactured by Tosoh Corporation). The measurement was performed under the following conditions. Note that the weight average molecular weight was determined in terms of polystyrene standard.

Sample concentration: 0.2% by mass (tetrahydrofuran (THF) solution)
Sample injection amount: 10 μl

### Eluent: THF

Flow rate: 0.6 ml/min
Measurement temperature: 40° C.

### Columns:

Sample column; TSK guard column Super HZ-H (1 column)+TSK gel Super HZM-H (2 columns)

Reference column; TSK gel Super H-RC (1 column) Detector: differential refractometer (RI)

(Measurement of Ratio of Solvent-Insoluble Component (Gel Fraction))

A ratio of a solvent-insoluble component was determined in the following way: after 0.1 g of a pressure-sensitive adhesive composition was sampled and precisely weighed (mass before dipping), this sample was dipped in approximately 50 ml of ethyl acetate at room temperature (20 to 25° C.) for 1 week; a solvent (ethyl acetate) insoluble portion was taken out, dried at 130° C. for 2 hours, and then weighed (mass after dipping and drying); and the ratio was calculated by using an equation for calculating the ratio: “solvent insoluble component ratio (mass %)=[(mass after dipping and drying)/(mass before dipping)]×100”.

Note that the ratio of a solvent-insoluble component (gel fraction) is preferably 80% by mass or more, and more preferably 90% by mass or more. If such ratio is within the above range, the cohesive strength of the pressure-sensitive adhesive layer is strong and the low staining properties are good. The measurement results are shown in Table 1.

### <Low-Speed Peeling Test: 180° Peeling Adhesive Strength>

The pressure-sensitive adhesive sheet according to each of Examples and Comparative Examples was cut into a piece having a size of 25 mm in width×100 mm in length. After the release liner was peeled off, the sheet was pressure-bonded, with a hand roller, to the surface of a triacetyl cellulose polarizing plate (SEG 1425 DU, width: 70 mm, length: 100 mm, manufactured by Nitto Denko Corporation) and then laminated under pressure-bonding conditions of 0.25 MPa and 0.3 m/min, thereby producing an evaluation sample (an optical film with an antistatic pressure-sensitive adhesive sheet).

After the lamination, the sample was left to stand under an environment of 23° C. and 50% RH for 30 minutes. The other surface of the triacetyl cellulose polarizing plate was fixed to an acrylic plate with a double-sided pressure-sensitive adhesive tape, and the pressure-sensitive adhesive strength, occurring when one end of the pressure-sensitive adhesive sheet was peeled off with a versatile tensile tester under the conditions of a tensile speed of 0.3 m/min (low-speed peeling) and a peeling angle of 180°, was measured. The measurement was performed under the conditions of 23° C. and 50% RH. The case where the adhesive strength occurring at low-speed peeling was 0.07N/25 mm or more was evaluated as good, while the case where the adhesive strength occurring at low-speed peeling was less than 0.07N/25 mm was evaluated as bad, from the viewpoint of suppressing the lifting and peeling of the pressure-sensitive adhesive tape. The measurement results are shown in Table 2.

### <High-Speed Peeling Test: 180° Peeling Adhesive Strength>

The pressure-sensitive adhesive sheet according to each of Examples and Comparative Examples was cut into a piece having a size of 25 mm in width×100 mm in length. After the release liner was peeled off, the sheet was pressure-bonded, with a hand roller, to the surface of a triacetyl cellulose polarizing plate (SEG 1425 DU, width: 70 mm, length: 100 mm, manufactured by Nitto Denko Corporation) and then laminated under pressure-bonding conditions of 0.25 MPa and 0.3 m/min, thereby producing an evaluation sample (an optical film with an antistatic pressure-sensitive adhesive sheet).

After the lamination, the sample was left to stand under an environment of 23° C.×50% RH for 30 minutes. Then, the other surface of the triacetyl cellulose polarizing plate was fixed to an acrylic plate with a double-sided pressure-sensitive adhesive tape, and the pressure-sensitive adhesive strength, occurring when one end of the pressure-sensitive adhesive sheet was peeled off with a versatile tensile tester under the conditions of a tensile speed of 30 m/min (high-speed peeling) and a peeling angle of 180°, was measured. The measurement was performed under the conditions of 23° C. and 50% RH. The case where the adhesive strength occurring at high-speed peeling was less than 6.0N/25 mm was evaluated as good, while the case where the adhesive strength occurring at high-speed peeling was 6.0N/25 mm or more was evaluated as bad. The measurement results are shown in Table 2.

### <Measurement of Surface Resistivity (Normal State)>

The pressure-sensitive adhesive sheet according to each of Examples and Comparative Examples was left to stand under an environment of 23° C. and 50% RH for 2 hours and the separator was peeled off. The surface resistivity of the pressure-sensitive adhesive surface was measured with a surface resistivity measurement device (Hiresta UP MCP-HT450 type, manufactured by Mitsubishi Chemical Corporation). The measurement was carried out at an applied voltage of 100 V for an application time of 30 seconds. The surface resistivity is preferably 10¹² or less, more preferably 10¹¹ or less. If the surface resistivity is within the above range, it becomes possible to prevent dust collection due to static electricity, and electrostatic hazards of electronic components, and thus this is useful. The measurement results are shown in Table 2.

### <Measurement of Saturated Charge Voltage>

The pressure-sensitive adhesive sheet according to each of Examples and Comparative Examples was cut into a piece having a size of 30 mm in width×30 mm in length, and left to stand for 1 day under an environment of 23° C. and 50% RH. After the separator was peeled off, the saturated charge voltage on the surface of the pressure-sensitive adhesive was measured by a static honestmeter (Static Honestmeter model H-0110, manufactured by Shishido Electrostatic, Ltd.) (the JIS-L1094 method). The measurement was performed at an applied voltage of 10 kV under an environment of 23° C. and 50% RH. As for the saturated charge voltage, its absolute value is preferably 1.0 kV or less, more preferably 0.6 kV or less. If the saturated charge voltage is within the above range, it becomes possible to prevent dust collection due to static electricity, and electrostatic hazards of electronic components, which makes the sheet useful. The measurement results are shown in Table 2.

### <Evaluation of Staining Property>

The pressure-sensitive adhesive sheet according to each of Examples and Comparative Examples was cut into a piece having a size of 20 mm in width×50 mm in length. After the separator was peeled off, the sheet was pressure-bonded to a triacetyl cellulose polarizing plate (SEG 1425 DU, manufactured by Nitto Denko Corporation) and then left to stand under an environment of 23° C. and 50% RH for 1 week. After that, the pressure-sensitive adhesive sheet was peeled off, and the state of staining on the surface of the adherend was observed with naked eyes. The case of no observation of staining was evaluated as good (◯) and the case of observation of staining was evaluated as bad (x). The measurement results are shown in Table 2.

TABLE 1

| | | Pressure-sensitive adhesive layer | | | | | | | |
|---|---|---|---|---|---|---|---|---|---|
| | Antistatic substrate film | (Meth)acrylic-based polymer | | | Ionic | Crosslinking | Crosslinking | Gel | |
| | Composition constituting | Polymer | Composition of | | compound | agent (C/L) | catalyst | fraction | Thickness |
| Composition | antistatic layer | used | polymer used | Parts | Parts | Parts | Parts | % by mass | μm |
| Example 1 | Antistatic resin composition | (A) | 2EHA/DMAEA-TFSI/HEA = | 100 | — | 4 | 0.03 | 96 | 20 |
| | solution (1) (containing | | 85/10/5 | | | | | | |
| | conductive polymer (PEDOT/PSS)) | | | | | | | | |
| Example 2 | Antistatic resin composition | (B) | 2EHA/DMAPAA-TFSI/HEA = | 100 | — | 4 | 0.03 | 96 | 20 |
| | solution (1) (containing | | 85/10/5 | | | | | | |
| | conductive polymer (PEDOT/PSS)) | | | | | | | | |
| Example 3 | Aluminum deposited layer | (A) | 2EHA/DMAEA-TFSI/HEA = | 100 | — | 4 | 0.03 | 96 | 20 |
| | | | 85/10/5 | | | | | | |
| Example 4 | Aluminum deposited layer | (B) | 2EHA/DMAPAA-TFSI/HEA = | 100 | — | 4 | 0.03 | 96 | 20 |
| | | | 85/10/5 | | | | | | |
| Example 5 | Antistatic resin composition solution | (A) | 2EHA/DMAEA-TFSI/HEA = | 100 | — | 4 | 0.03 | 95 | 20 |
| | (2) (containing (meth)acrylic-based | | 85/10/5 | | | | | | |
| | polymer (C) (DMAEA-TFSI/HEMA = 95/5) | | | | | | | | |
| Example 6 | Antistatic resin composition solution | (B) | 2EHA/DMAPAA-TFSI/HEA = | 100 | — | 4 | 0.03 | 95 | 20 |
| | (2) (containing (meth)acrylic-based | | 85/10/5 | | | | | | |
| | polymer (C) (DMAEA-TFSI/HEMA = 95/5) | | | | | | | | |
| Comparative | Antistatic resin composition | (D) | 2EHA/HEA = 96/4 | 100 | | 4 | 0.03 | 96 | 20 |
| example 1 | solution (1) (containing | | | | | | | | |
| | conductive polymer (PEDOT/PSS)) | | | | | | | | |
| Comparative | — | (D) | 2EHA/HEA = 96/4 | 100 | Lithium salt + | 2.5 | 0.03 | 94 | 15 |
| example 2 | | | | | polyether | | | | |
| | | | | | compound | | | | |

The abbreviations in Table 1 represent the following compounds. The ″parts″ in Table 1 represent a solid content.
2EHA: 2-Ethylhexyl acrylate
HEA: 2-Hydroxyethyl acrylate
HEMA: 2-Hydroxyethyl methacrylate
DMAEA-TFSI: 2-(Acryloyloxy)ethyltrimethylammonium bis(trifluoromethanesulfonyl)imide
DMAPAA-TFSI: (3-Acrylamidopropyl)trimethylammonium bis(trifluoromethanesulfonyl)imide
C/L (Coronate L): Trimethylolpropane/tolylene diisocyanate trimer adduct (crosslinking agent)
PEDOT/PSS: Poly(ethylenedioxythiophene)/polystyrene sulfonate (conductive polymer)

TABLE 2

| | Evaluation results | | | | |
|---|---|---|---|---|---|
| | 180° peeling | | Surface resis- | | |
| | adhesive strength | | tivity of pressure- | Saturated | Staining |
| | (vs DU) | | sensitive adhesive | charge voltage | property |
| | Tensile speed | Tensile speed | (Normal state) | Normal state | Normal state |
| | 0.3 m/min | 30 m/min | 23° C. × 50% RH | 23° C. × 50% RH | 23° C. × 50% RH |
| | (low speed) | (high speed) | After 2 hours | After 1 day | After 1 week |
| Unit | N/25 mm | N/25 mm | Ω/□ | kV | — |
| Example 1 | 0.401 | 3.03 | 6.4E+09 | 0.0 | ◯ |
| Example 2 | 0.311 | 2.28 | 1.2E+10 | −0.3 | ◯ |
| Example 3 | 0.316 | 1.58 | 1.4E+08 | 0.0 | ◯ |
| Example 4 | 0.234 | 1.25 | 1.9E+08 | 0.0 | ◯ |
| Example 5 | 0.412 | 2.38 | 9.0E+10 | −0.6 | ◯ |
| Example 6 | 0.389 | 2.55 | 5.4E+10 | −0.6 | ◯ |
| Comparative | 0.137 | 3.25 | 3.3E+12 | −1.6 | ◯ |
| example 1 | | | | | |
| Comparative | 0.034 | 0.45 | 4.3E+10 | −0.5 | X |
| example 2 | | | | | |

From the results shown in Table 2, it was confirmed that in all Examples, the sheets showed a surface resistivity of 10¹² or less, an absolute value of 1.0 kV or less in saturated charge voltage, a satisfactory pressure-sensitive adhesive property in high-speed and low-speed peeling, and further a satisfactory low staining property, and thus are useful as a repeelable pressure-sensitive adhesive sheet (pressure-sensitive adhesive layer).

On the other hand, since the pressure-sensitive adhesive layer in Comparative Example 1 was formed by using a (meth)acrylic-based polymer not containing a reactive ionic liquid as a monomer unit, it was confirmed that the surface resistivity and saturated charge voltage cannot satisfy a desirable range, resulting in deterioration of antistatic property. Also, in Comparative Example 2, since a pressure-sensitive adhesive composition containing, as an antistatic agent, a lithium salt and a polyether compound was used instead of using the (meth)acrylic-based polymer not containing a reactive ionic liquid as a monomer unit, an antistatic property was obtained, but the adhesive strength at the time of low-speed peeling was extremely low, which is of little practical use, and a staining due to the bleeding out of the antistatic agent component was observed. Therefore, it was confirmed that a pressure-sensitive adhesive sheet satisfying all of antistatic properties (surface resistivity, saturated charge voltage), adhesive properties, and low staining properties could not be obtained in any of Comparative Examples.

Summarizing the above, the evaluation results were all good in the antistatic pressure-sensitive adhesive sheets provided with a pressure-sensitive adhesive layer formed of a (meth)acrylic-based polymer containing a reactive (polymerizable) ionic liquid on the antistatic-treated surface of an antistatic substrate film, and it was confirmed that non-conventional effects could be obtained.

### DESCRIPTION OF REFERENCE SIGNS

10 Antistatic pressure-sensitive adhesive sheet (Adhesive sheet)
11 Separator
12 Pressure-sensitive adhesive layer
13 Antistatic layer
14 Substrate layer
15 Antistatic substrate film

1. An antistatic pressure-sensitive adhesive sheet comprising:
an antistatic substrate film; and
a pressure-sensitive adhesive layer on at least one side of the antistatic substrate film, wherein
the pressure-sensitive adhesive layer is formed of at least an antistatic pressure-sensitive adhesive composition comprising a (meth)acrylic-based polymer containing a reactive ionic liquid as a monomer unit.

2. The antistatic pressure-sensitive adhesive sheet according to claim 1, wherein the reactive ionic liquid content is 0.1 to 50% by mass based on the total constituent units of the (meth)acrylic-based polymer.

3. The antistatic pressure-sensitive adhesive sheet according to claim 1, wherein the reactive ionic liquid is represented by the following general formula (1) and/or (2):
CH2=(R1)COOZX+Y− (1)
CH2=C(R1)CONHZX+Y− (2)
[in the formulae (1) and (2), R1 is a hydrogen atom or a methyl group, X+ is a cation moiety, Y− is an anion. Z represents an alkylene group of 1 to 3 carbon atoms].

4. The antistatic pressure-sensitive adhesive sheet according to claim 3, wherein the cation moiety is a quaternary ammonium group.

5. The antistatic pressure-sensitive adhesive sheet according to claim 3, wherein the anion is a fluorine-containing anion.

6. The antistatic pressure-sensitive adhesive sheet according to claim 1, wherein
the antistatic substrate film has an antistatic layer on at least one side of a substrate layer, and
the antistatic layer is a layer containing at least one kind selected from the group consisting of a metal film, a conductive filler, an electronically conductive polymer, and an ion conductive polymer.

7. The antistatic pressure-sensitive adhesive sheet according to claim 6, wherein the ion conductive polymer is a polymer containing a reactive ionic liquid as a monomer unit.

8. The antistatic pressure-sensitive adhesive sheet according to claim 6, wherein the substrate layer is a plastic film.

9. The antistatic pressure-sensitive adhesive sheet according to claim 1, wherein the antistatic pressure-sensitive adhesive sheet is used for surface protection.

10. The antistatic pressure-sensitive adhesive sheet according to claim 1, wherein the antistatic pressure-sensitive adhesive is used for electronic components production and a shipment process.

11. An optical film with an antistatic pressure-sensitive adhesive sheet, wherein the antistatic pressure-sensitive adhesive sheet according to claim 1 is laminated to an optical film.
